(19) United States
(12) Patent Application Publication
(10) Pub. No.: US 2017/0193530 A1
(43) Pub. Date: Jul. 6, 2017

(54) MOBILE CUSTOMER ENGAGEMENT PLATFORM

(71) Applicant: The Younity Group, Frisco, TX (US)

(72) Inventors: Jackson Reed Newsum, Coppell, TX (US); Anthone Campbell, Frisco, TX (US); Nathan Don Charles, McKinney, TX (US)

(21) Appl. No.: 15/293,266

(22) Filed: Oct. 13, 2016

Related U.S. Application Data
(60) Provisional application No. 62/240,977, filed on Oct. 13, 2015.

(51) Int. Cl. G06Q 30/02; H04W 4/02; G06Q 50/00

(52) U.S. Cl. CPC G06Q 30/0201; G06Q 30/0217; G06Q 30/0281; G06Q 50/01; H04W 4/021; G06Q 30/02

(57) ABSTRACT

Customer engagement for a retail enterprise is facilitated by retail enterprise customer and management mobile device applications executing on mobile device and served by a retail enterprise server. Customer arrival may be determined by automatic discovery by and connection of the customer mobile device to a small area connectivity (e.g., iBeacon or other Bluetooth LE) system on the retail enterprise premises. The customer mobile device application allows the customer to access campaigns, offers and events, to pay for service, and to post reviews, likes and share to the customer's Facebook and Twitter feeds. Customers may be classified according to at least one of number of visits, number of reviews, and total spend. Various campaigns, offers, and events may be managed using the management mobile device application, and collective or broken-out information regarding customer, campaigns, offers and events accessed. Customer engagement during and between visits to the retail enterprise is facilitated.

### CROSS REFERENCE TO RELATED APPLICATIONS

The present application claims priority to U.S. Provisional Patent Application No. 62/240,977 filed Oct. 13, 2015 and entitled MOBILE CUSTOMER ENGAGEMENT PLATFORM. The content of the above-identified patent document is incorporated herein by reference.

### TECHNICAL FIELD

The present application relates generally to smartphone and tablet application (“app”) design, development and deployment for retail enterprises, and, more specifically, to mobile device apps enhancing customer engagement with a retail enterprise.

### BACKGROUND

Customer engagement (e.g., “mindshare,” loyalty, etc.) with a retail enterprise has become an increasingly important aspect of retail enterprise operations for such enterprises, particularly for restaurants and other entertainment venues. In some retail sectors, up to two-thirds of marketing expenditures are targeted to acquisition of new customers, despite the fact that a majority of first-time customers never return. By contrast, as much as (or in some cases more than) 80% of revenue for many retail enterprises originates from loyal, repeat customers that individually and collectively spend more on a per-visit basis than typical first-time customers. Fostering customer engagement is thus often an important factor in profitability.

At the same time, the activities of contemporary individuals are increasingly centered on personal mobile devices such as smart phones. In virtually every public forum, individuals who are waiting or even socializing may be seen using their mobile device, reading and/or sending text messages or similar correspondence (e.g., e-mails or “snaps”), reading and/or posting to social media, etc. Individuals are strongly influenced by activities involving their mobile devices, such interaction through social media (Facebook, Twitter, Snap, Instagram, etc.) and personal communications (text or multimedia messaging, phone calls).

Much mobile device use is now location-specific. Individuals “check in” at venues, including restaurants and other retail entertainment locales, using social media applications with geolocation capabilities. Individuals use applications on mobile devices to locate friends or family members, discover the nearby presence of friends, or “match” people that they wish to meet via global positioning system (GPS) or other location-identifying capabilities.

There is, therefore, a need in the art for improving customer engagement with retail enterprises through the customers' mobile devices.

### BRIEF DESCRIPTION OF THE DRAWINGS

For a more complete understanding of the present disclosure, and the advantages thereof, reference is now made to the following descriptions taken in conjunction with the accompanying drawings, wherein like numbers designate like objects, and in which:

FIG. 1 is a diagram of a system within which mobile device app design, development and deployment occur for facilitating customer engagement with a retail enterprise in accordance with embodiments of the present disclosure;

FIG. 1A is a more detailed view of a mobile device within the system of FIG. 1;

FIGS. 2A-2L depict user interfaces for a management mobile device app facilitating customer engagement with a retail enterprise in accordance with embodiments of the present disclosure;

FIGS. 3A-3K depict user interfaces for a customer mobile device app facilitating customer engagement with a retail enterprise in accordance with embodiments of the present disclosure;

FIG. 4 is a diagram illustrating a beacon process employed for customer and management mobile device apps facilitating customer engagement with a retail enterprise in accordance with embodiments of the present disclosure;

FIG. 5 is a diagram illustrating a VIP notification process employed for management mobile device apps facilitating customer engagement with a retail enterprise in accordance with embodiments of the present disclosure;

FIG. 6 is a diagram illustrating a messaging process employed between the customer and management mobile device apps facilitating customer engagement with a retail enterprise in accordance with embodiments of the present disclosure;

FIG. 7 is a diagram illustrating a mobile payment process employed for the customer mobile device app facilitating customer engagement with a retail enterprise in accordance with embodiments of the present disclosure;

FIG. 8 is a diagram illustrating a splash and login process employed for the customer mobile device app facilitating customer engagement with a retail enterprise in accordance with embodiments of the present disclosure;

FIG. 9 is a diagram illustrating a user profile edit process employed for the customer mobile device app facilitating customer engagement with a retail enterprise in accordance with embodiments of the present disclosure;

FIG. 10 is a diagram illustrating a user settings edit process employed for the customer mobile device app facilitating customer engagement with a retail enterprise in accordance with embodiments of the present disclosure;

FIG. 11 is a diagram illustrating a business profile access process employed for the customer mobile device app facilitating customer engagement with a retail enterprise in accordance with embodiments of the present disclosure;

FIG. 12 is a diagram illustrating a discover process employed for the customer mobile device app facilitating customer engagement with a retail enterprise in accordance with embodiments of the present disclosure;

FIG. 13 is a diagram illustrating an events process employed for the customer mobile device app facilitating customer engagement with a retail enterprise in accordance with embodiments of the present disclosure;

FIG. 14 is a diagram illustrating a to-go order process employed for the customer mobile device app facilitating customer engagement with a retail enterprise in accordance with embodiments of the present disclosure;

FIG. 15 is a diagram illustrating a wallet process employed for the customer mobile device app facilitating customer engagement with a retail enterprise in accordance with embodiments of the present disclosure;

FIG. 16 is a diagram illustrating an offers process employed for the customer mobile device app facilitating customer engagement with a retail enterprise in accordance with embodiments of the present disclosure;

FIG. 17 is a diagram illustrating a review process employed for the customer mobile device app facilitating customer engagement with a retail enterprise in accordance with embodiments of the present disclosure;

FIG. 18 is a diagram illustrating a social connect process employed for the customer mobile device app facilitating customer engagement with a retail enterprise in accordance with embodiments of the present disclosure;

FIG. 19 is a diagram illustrating a management user access setup process employed for the management mobile device app facilitating customer engagement with a retail enterprise in accordance with embodiments of the present disclosure;

FIG. 20 is a diagram illustrating a management user login process employed for the management mobile device app facilitating customer engagement with a retail enterprise in accordance with embodiments of the present disclosure;

FIG. 21 is a diagram illustrating a management user control process employed for the management mobile device app facilitating customer engagement with a retail enterprise in accordance with embodiments of the present disclosure;

FIG. 22 is a diagram illustrating a management location selection process employed for the management mobile device app facilitating customer engagement with a retail enterprise in accordance with embodiments of the present disclosure;

FIG. 23 is a diagram illustrating a management location dashboard process employed for the management mobile device app facilitating customer engagement with a retail enterprise in accordance with embodiments of the present disclosure;

FIG. 24 is a diagram illustrating a management campaigns dashboard process employed for the management mobile device app facilitating customer engagement with a retail enterprise in accordance with embodiments of the present disclosure;

FIG. 25 is a diagram illustrating a management customer dashboard process employed for the management mobile device app facilitating customer engagement with a retail enterprise in accordance with embodiments of the present disclosure;

FIG. 26 is a diagram illustrating a management dynamic menu dashboard process employed for the management mobile device app facilitating customer engagement with a retail enterprise in accordance with embodiments of the present disclosure;

FIGS. 27 and 28 are diagrams illustrating counterparts for a net promoter score process employed for the customer and management mobile device apps facilitating customer engagement with a retail enterprise in accordance with embodiments of the present disclosure;

FIGS. 29A-29C are a diagram illustrating a management new campaign process employed for the customer and management mobile device apps facilitating customer engagement with a retail enterprise in accordance with embodiments of the present disclosure;

FIG. 30 is a diagram illustrating a management past customers process employed for the customer and management mobile device apps facilitating customer engagement with a retail enterprise in accordance with embodiments of the present disclosure;

FIGS. 31A-31B are a hierarchical diagram illustrating the general functionality accessible by the customer and management mobile device apps facilitating customer engagement with a retail enterprise in accordance with embodiments of the present disclosure.

### SUMMARY

Customer engagement for a retail enterprise is facilitated by retail enterprise customer and management mobile device applications executing on mobile device and served by a retail enterprise server. Customer arrival may be determined by automatic discovery by and connection of the customer mobile device to a small area connectivity (e.g., iBeacon or other Bluetooth LE) system on the retail enterprise premises. The customer mobile device application allows the customer to access campaigns, offers and events, to pay for service, and to post reviews, likes and share to the customer's Facebook and Twitter feeds. Customers may be classified according to at least one of number of visits, number of reviews, and total spend. Various campaigns, offers, and events may be managed using the management mobile device application, and collective or broken-out information regarding customer, campaigns, offers and events accessed. Customer engagement during and between visits to the retail enterprise is facilitated.

Before undertaking the DETAILED DESCRIPTION below, it may be advantageous to set forth definitions of certain words or phrases used throughout this patent document: the terms “include” and “comprise,” as well as derivatives thereof, mean inclusion without limitation; the term “or” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any hardware device that controls at least one operation, whether based upon firmware or user-supplied software executing within the controller. It should be noted that the functionality associated with any particular controller might be centralized or distributed, whether locally or remotely. Definitions for certain words and phrases are provided throughout this patent document, and those of ordinary skill in the art will understand that such definitions apply in many, if not most, instances to prior as well as future uses of such defined words and phrases. While some terms may include a wide variety of embodiments, the appended claims may expressly limit these terms to specific embodiments.

### DETAILED DESCRIPTION

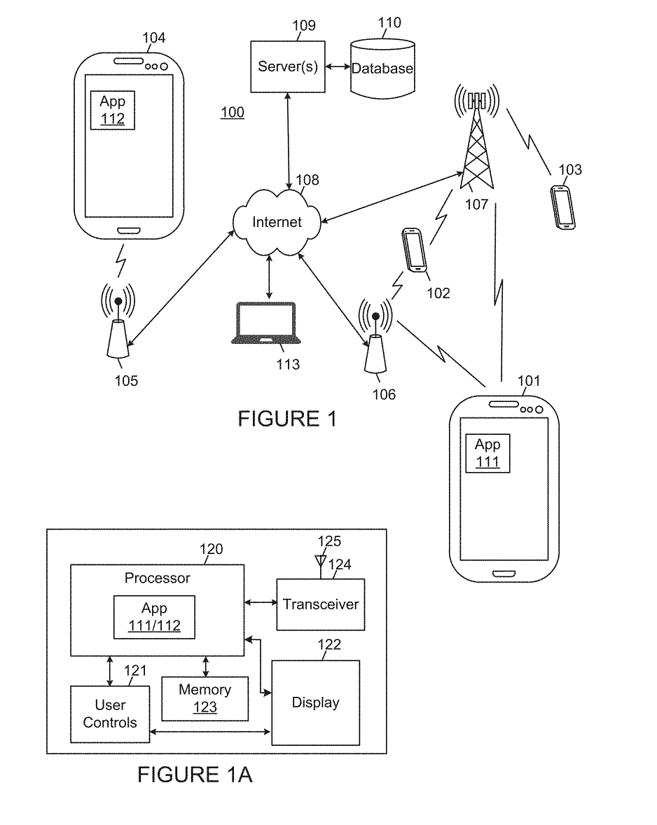

FIGS. 1 through 31, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system.

A mobile device app facilitating customer engagement with a specific retail enterprise is quickly designed and deployed for the retail enterprise. The app is operable on mobile devices including smart phones or tablets, as well as wearable mobile devices such as watches and glasses, and may be quickly deployed across different mobile device operating system platforms (e.g., iOS or Android). The app facilitates location-specific customer engagement by the retail enterprise, especially through small area connectivity systems such as Bluetooth low energy (LE) communications.

In the context of a restaurant, for example, the app may facilitate the provision and personalization of customer service from the moment of the customer's arrival. Initial connection of the app on the customer's mobile device with a restaurant's small area connectivity system may trigger a prompt on a tablet at the hostess stand and/or carried by wait staff, where the prompt includes the customer's image and preferred name to allow the customer to be recognized and greeted by name by restaurant employees that have never before met that customer. The same initial connection may also selectively trigger immediate or time-delayed notifications on the mobile devices carried by a manager or chef on duty at the restaurant, to alert restaurant management to the presence of an individual considered by the enterprise to be a VIP in order to facilitate personal customer interaction. For instance, after lapse of a predetermined time following seating of the customer, the chef may receive (or look up) an indication of the table at which the customer has been seated, so that the chef may stop by that table to socialize with the customer.

The mobile device app may also facilitate customer engagement through the provision and personalization of the customer's dining experience. For example, the app may enable the customer to signal “do not disturb,” “ready to order,” or “ready for check” to the restaurant's staff. In addition (or alternatively), special offers for discounts and daily specials (e.g., off-menu items) or recommendations may be presented to the customer via the mobile device app, either upon arrival, immediately after seating, or timed to coincide with a server describing daily specials or taking the customer's order. The offers or recommendations may be customized for the specific customer based on information regarding the customer's dietary restrictions or food allergies, past ordering history and feedback from the customer following prior meals, or recommendations of the customer's friends and acquaintances linked to the customer's social media accounts. As another example, the mobile device app may be used for payment.

The mobile device app may further facilitate customer engagement in between occasions when the customer dines at the restaurant. Offers, event notifications, and campaign notifications may be sent to the customer, including those triggered by the customer's unusually long absence between visits, those keyed to specific dates, or those simply sent to elevate mind share.

FIG. 1 is a diagram of a system within which mobile device app design, development and deployment occur for facilitating customer engagement with a retail enterprise in accordance with embodiments of the present disclosure. The system 100 includes a customer mobile device 101, which is one of a plurality of mobile devices 102, 103 and 104 associated with different users within a given geographic region. At least one of mobile devices 102, 103 and 104 is employed by a retail enterprise, carried and/or used by an on-duty staff employee of the retail enterprise, or optionally by a management-level employee that regardless of whether that person is on or off duty. In the description below, customer mobile device 101 is used as an example of a plurality of mobile devices 101-102 used by customers of a retail enterprise, which enterprise mobile device 104 is used as an example of a plurality of mobile devices 103-104 used by the retail enterprise.

The mobile devices 101-104 may each include at least a smart phone or tablet, and optionally may encompass an associated wearable mobile device accessory such as a watch wirelessly coupled to and operating in conjunction with a smart phone. Each mobile device 101-104 is configured for wireless voice or data communications with others of the mobile devices 101-104, either directly or via one or more of a wireless fidelity (WiFi) network or other wireless local area network (LAN) via access points 105 and 106, a wireless wide area network (e.g., WiMAX), or a broadband wireless voice and data communications network (e.g., 4^{th} Generation Long Term Evolution or “4G LTE”) via base station 107. Each of the mobile devices 101-104 communicates directly or indirectly via the above-described wireless communications to the internet 108, to which is connected a server 109 that operates on behalf of the retail enterprise and that selectively accesses a data store 110 coupled to the server 109. The server 109 executes one or more programs for the retail enterprise, which program(s) provide specific functionality in connection with mobile devices 101-104 described in further detail below.

At least the customer mobile device 101 and the retail enterprise mobile device 104, and preferably the other mobile devices 102-103, includes an app 111, 112 distributed by the retail enterprise. The app 111, 112 executes on the respective mobile device and interoperates with the program(s) executing on the server 109. Apps 111 and 112 may be identical apps operating in different modes—for example, app 111 executing on customer mobile device 101 operating in customer mode, and app 112 executing on retail enterprise mobile device 104 operating in management mode. Preferably, however, apps 111 and 112 are counterparts. That is, app 111 executing on customer mobile device 101 is a customer app having a certain defined set of user controls, functionality, and interoperability with one or both of the program(s) executing on server 109 and the app 112 executing on the retail enterprise mobile device 104. App 112 executing on the retail enterprise mobile device 104 is a management app having a different defined set of user controls, functionality, and interoperability with one or both of the program(s) executing on server 109 and the app 111 executing on the customer mobile device 101. The functionality of apps 111-112 is complementary, providing counterpart sub-processes and user operations for an overall process, and may be somewhat overlapping.

Each of the mobile devices 101, 102, 103, and 104 includes the general structure shown in FIG. 1A. A processor 120 is coupled to user controls and display 121, 122, such as a touch screen display for displaying graphics and text for the user and for receiving user input from the user. Some user controls 121 may be separate from the display 122, and some portions of the display 122 may not function as user controls 121. The processor 120 is also coupled to a memory 123 storing a mobile device operating system executed by the processer, applications executed by the processor, and user-specific data (including images) on which the applications operate. Processor 120 is further coupled to and controls a wireless transceiver 124, which may operate to communicate via antenna 125. Except as specifically described below, the mechanism by which certain wireless communications used during customer engagement by retail enterprise in accordance with the present disclosure is not generally critical.

Each of the mobile devices 101-104 further includes app 111 or 112 stored in the memory 123 within the respective device and selectively executed (actively or in the background) on the processor 120 of the respective device under at least initial control of a user. The app 111, 112, when executing, causes the respective mobile device to function as part of the overall system for facilitating customer engagement with a retail enterprise in accordance with embodiments of the present disclosure, as described in further detail below.

Those skilled in the art will understand that the full structure and operation of the system 100, including the server 109 and the mobile devices 101-104, is not illustrated in the drawings or described herein. Instead, for simplicity and clarity, only so much of the structure and operation of the system 100, the server 109, and the mobile devices 101-104 as is unique to the present disclosure or necessary for an understanding of the present disclosure is depicted and described. Other components may be employed within system 100, and other functionality included in the system 100, the server 109, and the mobile devices 101-104. For example, a global positioning system (GPS) receiver or WiFi-based location system in each mobile device 101-104 may provide location information for the respective mobile device to the processor, for use in geolocation for some embodiments. Server 109 is also preferably configured to allow connections by a program executing on a remote laptop or desktop system 113 to be used to update the same information within data store 110 that is described below as being set or changed by the management app 112. In general, the same functionality described below for management app 112 is also available through a laptop or desktop system 113.

Access points 105 and 106 in system 100 are preferably, but not necessarily, small area connectivity system devices. Small area connectivity system device typically have a communication range limited to less than 100 meters, although in some instances the range may extend up to approximately 500 meters. By preference, the small area connectivity system formed by access points 105 and/or 106 utilizes one or more Bluetooth LE devices, each of which may be readily implemented using iBeacon devices from Apple Inc. When forming a small area connectivity system using one or both of access points 105 and 106, the location of access points 105 and/or 106 and the power levels settings are preferably used to provide coverage within substantially all of an interior of the retail enterprise service areas. In the example of a restaurant retail enterprise discussed above, the coverage area should preferably encompass the customer service areas and the food preparation and retail enterprise offices areas. In addition, external areas leading up to the restaurant's entrance (e.g., portions of the parking lot or walkways leading to the entrance) may be covered. Beyond such areas, however, coverage by the small area connectivity system is preferably limited or non-existent, except for special situations.

Illustrative embodiments of the present disclosure include mobile customer engagement platforms comprising at least one of a management application and a consumer application, possibly in combination with associated beacons, back-end processing elements and other components. The management and consumer applications in some embodiments run on respective processing devices of a network-based information processing system. Examples of such processing devices include mobile smartphones, tablets, laptops or other types of communication devices. These devices and other processing devices of the system are implemented using one or more processing platforms which illustratively comprise multiple networked processing devices.

In some embodiments, a mobile customer engagement platform is more particularly implemented as a Younity 360 (Y360, also known as PeopleIQ) platform. Such a platform illustratively provides a complete set of tools that connects retail enterprises with their customers to help the retail enterprise achieve a greater share of their customers' awareness of and attention to the retail enterprise (“mind” or “mindshare”), planned expenditure for certain products and services within a specific category of retail enterprise or within groups of retail enterprise categories or various types of retail enterprises (“spend” or “planned purchasing”), and enhances or increases the chances that the consumer will continue to purchase from the retail enterprise, as well as “advocate” for or promote others to purchase from, and further recommend others to purchase from retail enterprise, as well as recommend others to purchase from the retail enterprise (“loyalty”). Accordingly, the Y360 platform can cause a consumer to make a choice to purchase a product or service from a retail enterprise that is using the platform instead of purchasing from a retail enterprise that is not using the Y360 platform.

Some embodiments of the Y360 platform comprise two mobile device applications 111, 112 that run on respective mobile smartphone and tablet devices 101, 104 running the iOS or Android mobile operating systems, as well as beacons (e.g., iBeacons) 105, 106 and other components. The beacons 105, 106 can be implemented, for example, as a class of Bluetooth low energy (LE) programmable hardware and firmware devices that broadcast their identifiers to nearby portable electronic devices. The beacon technology enables smartphones, tablets and other devices to perform actions when in close proximity to a beacon.

The two component applications are generically labeled the “Management App” (also referred to as the “Management Console”) 112 and the “Consumer App” 111. The applications 111, 112 and beacons 105, 106 operate together in illustrative embodiments as part of a mobile customer engagement platform that enables a manager, customer or other user to perform and make use of various functionalities made available by software coding within that platform. For example, combinations of software and hardware functionalities disclosed herein can deliver specific benefit and value to both consumers and retail enterprise operators. Portions of a given mobile customer engagement platform in some embodiments can be implemented using mobile back-end as a service (mBaaS) components.

The Y360/PeopleIQ platform in some embodiments illustratively comprises management and consumer applications 111, 112 having full Application Programming Interface (API) capabilities so as to facilitate integration with other applications or integration into other applications. For example, with full API capability, the Y360 platform can be seamlessly integrated into most of the major brand Point-of-Sale (POS) systems on the market today, and is built to be flexible enough to integrate with a wide variety of other POS configurations or other types of systems or devices, including big data analytics systems.

The Y360 platform can be implemented in its native form branded as “Younity 360” or can be “white-labeled,” “private-labeled,” or “rebranded” with the brand of the retail enterprise that subscribes to the platform, so as to exist to the user as a custom mobile device application built specifically for the retail enterprise. The Y360 platform can be modified to meet the customized feature/functionality needs of the retail enterprise subscriber, should additional or different feature/functionality be required by the retail enterprise subscriber that is not contained in the Y360 platform in its native form.

The attached drawings illustrate various aspects of the management application, consumer application and other system components in illustrative embodiments. Such arrangements are considered illustrative embodiments of at least portions of a mobile customer engagement platform as disclosed herein.

Additional description below provides separate listings of example features and/or functionality of the management application and the consumer application, to be read in conjunction with the attached drawings. It is to be appreciated that the features/functionalities of these applications as listed below are exemplary only, and additional or alternative arrangements of features and/or functionalities can be used in other embodiments.

Example Features/Functionality of the Management Application

1. Single or multi user login capabilities.

2. Leadership and their staff have the ability to manage a single location and or multiple locations from within the Y360 Management App.
a. Single site Manager—Allow the retail enterprise operator to control all Management App feature/functionality for one site (or copy of the Management App)
b. Multi-site Manager singular access to all retail enterprise locations with customer, campaign and usage analytics in a roll-up or individual view.

3. Collects real-time retail enterprise data and presents it in an easy-to-read and understand “Dashboard”
a. The dashboard comprises the following elements:
   i. Number of Campaigns Sent
   ii. Number of App Downloads
   iii. Number of Customers “On-Site”
   iv. Number of Customers “Nearby” based on a customizable proximity value set by the retail enterprise leadership.
   v. Aggregation of patron Net Promoter Score survey results
   vi. Combined Average Return Visits of patrons
   vii. A ratio of new customers vs return customers
   viii. Demographics of the retail enterprise's customers that have the application
      1) Male, Female or Other
      2) Average spend (dollars per sale) of each of the male and female subset groups
      3) New customer growth by time period based on a month by month metrics collected from “New” customers to a specific location that have the app installed.

4. Social Connect
a. Centralized access to various social media feeds with management app
b. Ability to post to multiple social media platforms from one post within the Y360 Social Connect feature.

5. Campaigns
a. The retail enterprise operator has real-time access to generating push notification messages to the Consumer App in the form of an “Offer.”
   i. Geographically
   ii. Filters
      1) Demographics
      2) Preferences
      3) Sales History
      4) Visit History
      5) Profile Data
   iii. Campaigns can be ad hoc, pre-scheduled, and expired/terminated dynamically.
   iv. Calculates the number of people in a given geographic area that have the Consumer App; based on dynamic geo-fencing capability.
   v. Calculates the number of people in a given geographic area that have “favorited” the retail enterprise by adding them to their “Younity 360 Wallet.”
   vi. Provides the capability to “Deep Link” offers to display/promote additional content or information in the form of images, audio and video.
   vii. Offers will have the ability for consumers to accept/collect incentives and promotions for future use as well as RSVP.

6. Customer Data
a. Provides real-time analytics about the retail enterprise's customers that have the application installed.
   i. App users are considered a customer of the specific location once they have been within proximity of the retail enterprise's beacon for a predetermined time.
   ii. Customer list contains the following elements:
      1) Number of Customers
      2) Number of Customers Nearby based on a predetermined range
      3) Number of Customers currently “On-site” at location
      4) Customer list with: Name, @Current Location, Average Reviews Rating, Dollar Spend & Number of Visits
      5) Ability to filter customers by Number of Reviews, Total Spend & Number of Visits.
   iii. Customer details contain the following elements:
      1) Customer name
      2) Customer City and State
      3) Average Review Rating
      4) Number of Reviews
      5) Dollar Spend
      6) Number of Visits
      7) All pictures submitted by customer for that specific retail enterprise
   8) Reviews for that specific retail enterprise.
   iv. Ability to “Message” customer directly from within Management App

7. Events
a. Provides the ability to create, edit and delete events for the retail enterprise
b. Events will be generated in the retail enterprise's consumer app and will allow for consumers to RSVP, Like and Share the event to others.
c. Users have the ability to create a new event with the following elements:
   i. Event Banner Image
   ii. Event Title
   iii. Event Start & End Date
   iv. Event Start & End Time
   v. Event Description

8. In-App Messaging
a. Allows the retail enterprise operator to send and receive in-app text messages to the Consumer.

9. Dynamic Menu
a. Allows the retail enterprise operator to dynamically generate menu items with the following elements:
   i. Item Name
   ii. Item Image
   iii. Item Cost
   iv. Item Description

10. User Access
a. Allows the retail enterprise operator to dynamically add users to the management system with the following elements:
   i. User Name
   ii. Email Address
   iii. User Type
   iv. User Privileges

11. To-Go Order Data
a. Integrated with various mobile ordering platforms based on customers' needs.

12. Campaign Acceptance
a. Allows retail enterprise to create time based offers.
b. Allows consumers to add offers to their wallet for future redemption.
c. Once offers are added to the wallet the timer will begin to countdown to expiration time to help drive need to redeem.

13. Integrate Open Table
a. Integration to the OpenTable API for dynamic table reservations for a specific restaurant.

14. Reserve Table
a. When consumer drive to a specific restaurant they will be presented with a “Welcome” message following by the following processes:
   i. “Would you like to reserve a table?” Yes or No?
   ii. “Would you like to pre-order drinks and appetizers?” Yes or No?
   iii. “How many in your party?”
   iv. “Great, your table will be ready in X minutes” based on table management API.
b. Consumer will be presented with a “Seat Available” timer view with capabilities of advertisement by the retail enterprise.

15. Onsite VIP Notification
a. Notification to leadership of “on-site” VIP based on the following criteria:
   i. How many visits
   ii. How many reviews
   iii. Dollars spent

16. Uber Integration
a. Ability to book a Uber ride directly via the following methods:
   i. Existing offer
   ii. Retail enterprise Detail Screen

17. Post to Facebook on LIKE
a. If social sharing on, the application will post user initiated “Likes” to their Facebook wall.

18. Add Server Name to Review
a. Capability to add the Server name to a dynamic net promoter request.
b. Reviews and ratings posted to mobile backend as a service (mBaaS).
c. Review posted to dynamic leaderboard located near POS System to create a gamification model to drive better service and engagement.
d. Leaderboard will be stacked ranked based on daily reviews submitted by customers.

19. Post Offer to Facebook and Twitter
a. Ability to automatically post new offers to the retail enterprise's Facebook and Twitter feeds.

20. Integrate Omnivore
a. Point of sale (POS) integration with Omnivore

21. Integrate Factual
a. Integration with Factual database to provide the following:
   i. Real-time access to retail enterprise locations around consumer
   ii. Filter retail enterprises by specific criteria to narrow search
   iii. Search function to provide specify listing based on user needs

22. Integrate Coupon API
a. Integration with Coupon API to offer consumer benefits such as:
   i. Aggregated coupons across multi coupon providers

Example Features/Functionality of the Consumer Application

1. Offers—Receive push-notification messages, called “Offers” generated via Management App Campaign functionality.
a. Notifications are accessed by selecting the “Offers” icon on the function menu located at the bottom of the screen. Notifications may contain any or all of the following:
   i. Photo
   ii. Text
   iii. Deep-linked capability
      1) The capability for the user to link to another page by tapping the Offer, such as connection to the home page of the retail enterprise that sent the Offer or to splash page that provides additional information (text, photo, or additional links to additional online media)
b. User can share the offer, posting it to Facebook and Twitter if consumer has sharing capability activated
c. Users can select the “thumbs up” icon to “like” the offer
d. The Offer calculates and displays the number of “likes,” “shares,” and “check-ins” initiated by users of the Consumer App.
e. Offers sent by the Management App are received by all Consumer Apps designated by criteria initiated by the Management App, typically geographically selected by the Management App's user by functionality contained within the Dynamic Campaign feature of the Management App.
f. Offers received by the Consumer App are presented to the user in an “Offer Feed”: a series of offers that appear vertically stacked in sequential order determined by time received—that is, vertically scrollable up and down by the Consumer App user.
g. Offers received by the Consumer App will alert the consumer App user according to the following methodology:
   i. If the retail enterprise that sent the offer has been “added to the user's wallet” (reference this functionality described in “Discover” below), the user will be alerted according to the Notifications Settings selected by the user on their mobile device for the Consumer App.
   ii. If the retail enterprise that sent the offer has not been added to the user's wallet, the Offer will appear in the Offer Feed, however the user will not be alerted, regardless of the general alert settings set for the Consumer App within the mobile device Notifications Settings.
h. Offers display the amount of time passed since the Offer was sent by the Management App.
i. Each offer will show profile picture of other consumers that are on-site of the retail enterprise that sent the offer. By tapping on the profile picture, users will be presented with the associated profile information such as Name, Photo, Reviews, Photos and Star Rating.
j. Offers that are accepted or added to the customer's “wallet” have a time sensitive expiration on them based on the retail enterprise's needs.

2. Discover
a. Displays a list of active retail enterprises within a geographic proximity
b. Retail enterprise listings are presented in vertical order, and can be scrolled up and down by the user using scrolling functionality inherent in the mobile device operating system.
c. Each retail enterprise listing displays the following:
   i. The name and logo of the retail enterprise
   ii. The vertical market sub-category description of the retail enterprise (i.e., Fresh Seafood for Restaurants>Fresh Seafood)
   iii. The average Promoter Score ratings given by users of the Consumer App displayed by number of stars on a 5-star scale
   iv. The location of the restaurant in terms of distance from the user, displayed in miles
d. Each Retail enterprise listing is deep-linked to the Retail enterprise's Profile page that displays:
   i. User selectable photo graphic of the retail enterprise—(Profile Header)
   ii. The name of the retail enterprise
   iii. A “heart” icon that when selected, indicates the retail enterprise is “favorite” by the user, adds the retail enterprise to the user's Wallet, and allows the user to be alerted according to the Notification Settings configured within the Mobile Device Operating System Settings.
   iv. The vertical market sub-category description of the retail enterprise
   v. Average Net Promoter Score rating displayed by number of stars on a 5-star scale
   vi. Number of customer reviews
   vii. A Share icon—that when selected, a Share Screen is displayed. Share Screen can include any number of applications for sharing, printing, or saving the data including:
      1) Airdrop
      2) Messaging
      3) Facebook
      4) Notes
      8) More . . .
      9) Copy
      10) Print
      11) Save image
      12) Assign to contact
      13) More . . .
   viii. Add Review icon—when selected, user is taken to the Add Review page
      1) User can tap a star to “rate” the retail enterprise by selecting a star icon on a 1 to 5 star scale
      2) User can add a personal review using free form text
      3) Add wait staff name (tracked via “Staff Leaderboard”)
      4) User can post their review and rating by tapping “send”
      5) User can cancel their post by tapping “cancel”
   ix. Add Photo icon
      1) When the Add Photo button is tapped, the device OS displays the following:
         a) Camera—when selected, the user may use the device camera to take a photo and add it to the retail enterprise profile page
      2) Photos are stored horizontally across the bottom of the page in a section called “PHOTOS” and are bi-directionally scrollable view
      3) Phone icon and phone number when tapped, the user is presented with a window enabling them to call the number or cancel the action
   x. Location icon with retail enterprise address and city.
      1) When tapped, user is taken to a page showing the default map of the device OS, with a location marker (pin) indicating the location of the retail enterprise graphically
      2) Map page includes the device OS “share” icon, allowing user to share the location of the retail enterprise

3. Events
a. Selecting the Events icon within the Consumer app displays all retail enterprises that have posted events. Retail enterprise listings are displayed in vertical stacked order, with each listing displaying the following:
   i. Retail enterprise name and logo
   ii. The name of the event
   iii. Date and times of the event
b. Selecting a retail enterprise listing
   i. Displays the retail enterprises Event Home Page
   ii. Retail enterprise photo/logo
   iii. RSVP button—communicates user intent to attend event
      1) Populates RSVP′d data on Retail enterprise Profile page, adding to number of RSVP's for event
      2) Communicates with database containing event origination data, adding to number of RSVP's
      3) Like button—Increases number of Likes on retail enterprise's Events Home Page
      4) Share button—Displays Device OS share options screen
      5) Events information details

4. Messages—In-app Messaging between anyone having the Consumer App and/or the Management App

5. Wallet—the Wallet is where the user of the Consumer App raises the importance of a retail enterprise to themselves by “favoriting” that retail enterprise.
a. By including the retail enterprise in the wallet environment, they opt-in to being alerted when retail enterprises push out offers, events and messaging. The user is alerted according to the parameters of Notifications functionality set up in the Settings of the Device Operating System
b. The Wallet displays the user's profile picture and when tapped, the user is taken to a repository of all of the photos and reviews they have posted
c. The Wallet contains retail enterprise listings within a list called “Memberships,” which is displayed vertically on the screen. The listing displays the date the user became a member (added the retail enterprise to the Wallet)
d. When the retail enterprise listing is tapped, the user is taken to the retail enterprise's profile page

6. Mobile Payment
a. User is able to seamlessly use the Consumer App to pay for products and services
   i. View/Review Sales Check/Order/Ticket
   ii. Add Gratuity
      1) Ad hoc selection of gratuity amount or percentage of check
      2) Set gratuity amount or percentage in advance
   iii. Split the Bill with others who have either the Consumer App or the Mobile Payment App integrated with the Y360 Consumer App
   iv. Selectable Payment Option
      1) Automatically pays upon disconnection with Beacon or Geofence
      2) Payment must be authorized—requiring manual approval by completing an action such as tapping a button called “approve transaction”
   v. Utilizes Apple Pay or Google Wallet functionality/integration

Again, the particular features/functionalities given above are presented by way of illustrative example only, and other embodiments can incorporate additional or alternative features/functionalities. Also, different subsets of the listed features/functionalities can be configured in different embodiments.

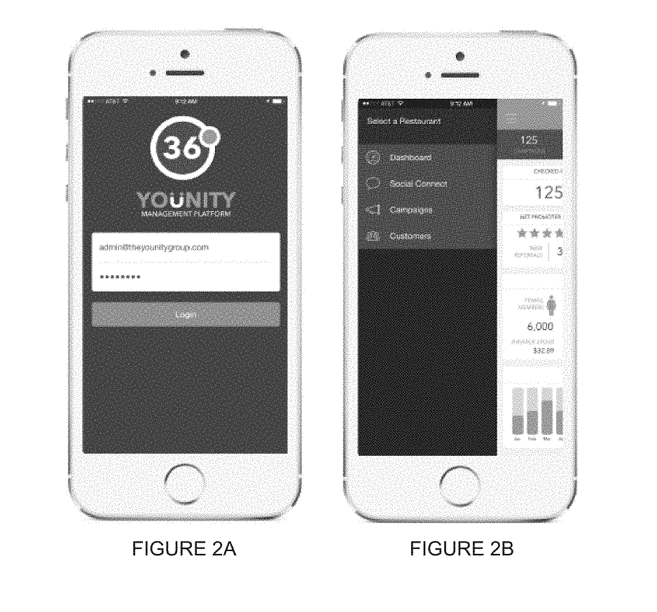

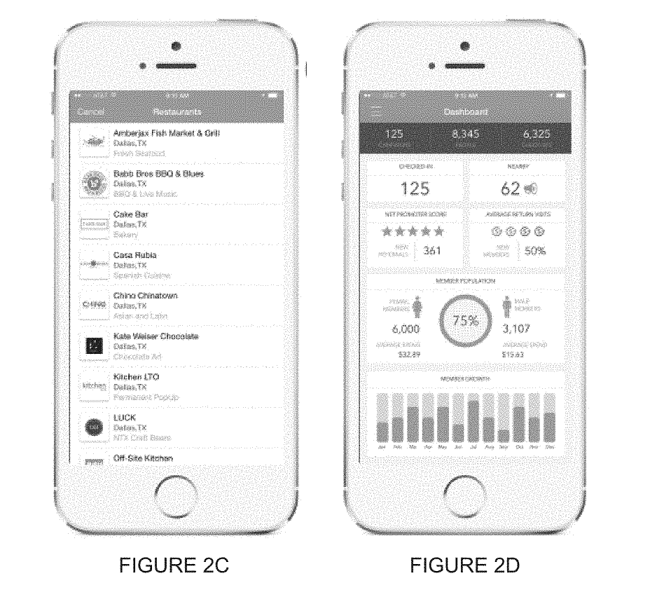

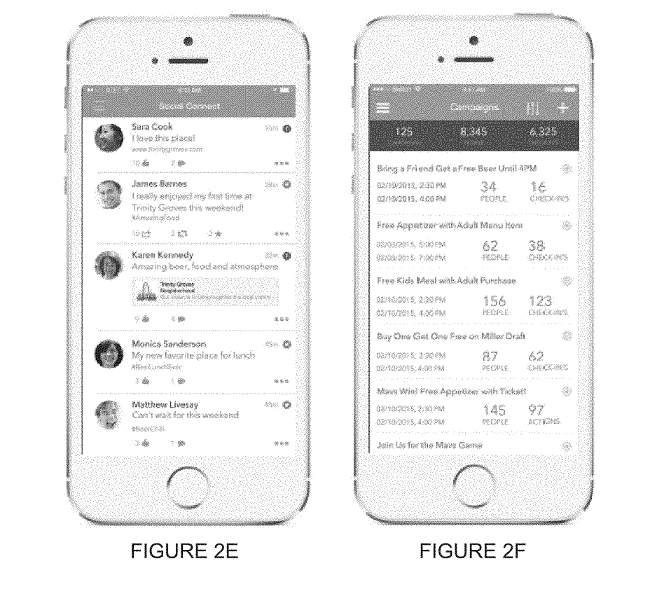

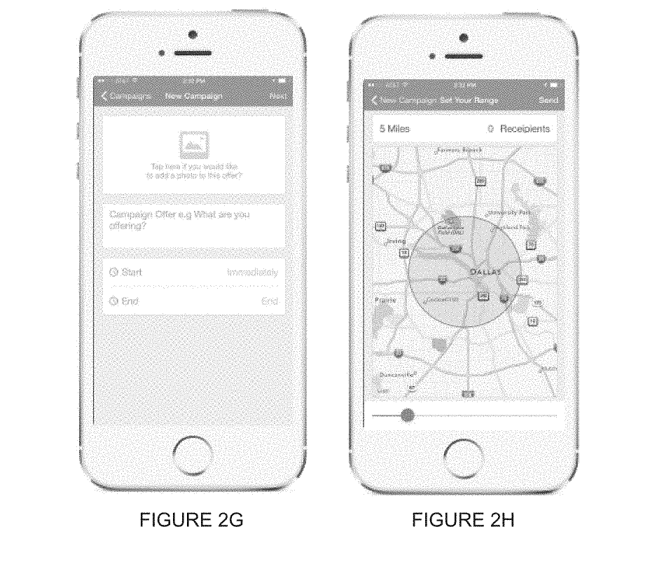

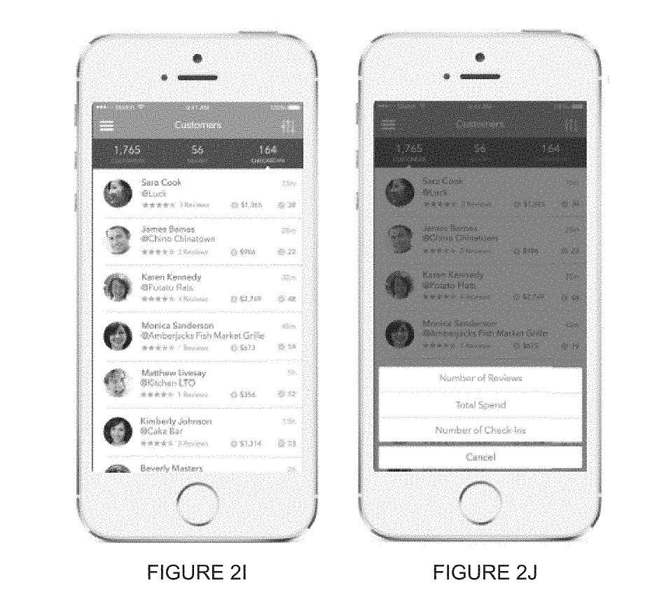

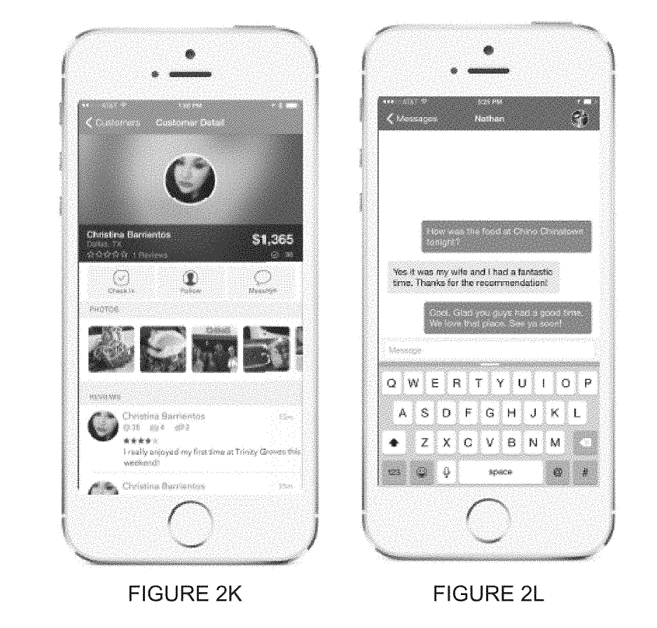

FIGS. 2A-2L depict user interfaces for a management mobile device app facilitating customer engagement with a retail enterprise in accordance with embodiments of the present disclosure. These user interfaces for management mobile device app 112 executing on mobile device 104 are generated during operation interacting with server 109 and/or mobile device app 111 executing on mobile device 101. FIG. 2A depicts a login screen, through which a management user has the ability to log into the management application via email address and password. FIG. 2B depicts a navigation menu, via which a management user has access to navigation of features to: select a restaurant; view Key Performance Indicator Dashboard; view a Social Connect interface; view Campaigns; view Customers; and access Messaging.

FIG. 2C illustrates a display produced by the management user selecting a specific restaurant and or a parent organization to: choose a specific individual restaurant allowing key performance indicators based on that location to be viewed; choose a specific individual restaurant to create, edit and delete campaigns based on that location; choose a specific individual restaurant to view customer information based on that location; choose a parent organization to view key performance indicators, create/edit/delete campaigns, as well as view customer information based on that rollup.

FIG. 2D illustrates a key performance indicator dashboard produced by the management user selection of that dashboard, with the following elements that may be viewed from a parent perspective with all information and data presented as a rollup or at a specific location level: total number of campaigns sent; total number of users within the application; total number of (customer) check-ins; current count of checked-in customers at the location; current count of customers nearby (range for “nearby” determined by user settings); average net promoter score, as determined by automated interaction based on visit counts; average return visit; member population broken into male versus female; average spend broken into male versus female; and member growth month by month.

FIG. 2E illustrates a Social Connect user interface allowing a management user to access the following features within the social connect functionality of the management application 112: integrated view of social network feeds such as Twitter and Facebook; and ability to update Twitter and Facebook feeds by posting a single update that simultaneously publishes to both Twitter and Facebook at the same time.

FIGS. 2F through 2H illustrate various user interfaces available to the management user for dynamic campaigns. Through the interface of FIG. 2F, a management user has access to a dynamic campaigns platform with the following features: dashboard with campaign analytics that include total number of campaigns, total number of recipients that have received a campaign and the total number of check-ins related to the campaigns that were sent; list of campaigns that contains, for each campaign, information including a campaign description, campaign type, time and date the campaign was sent or time and date the campaign is scheduled to be sent; time and date of the expiration of the campaign; total number of people to which the campaign was sent; total number of check-ins related to the campaign; and filtering of campaigns by date sent, date scheduled, number of recipients, number of check-ins. The management user has the ability to interact with campaigns in the following ways: creating a new campaign; editing an existing campaign; deleting a campaign; or reposting a campaign. FIG. 2G illustrates a user interface for a management user creating a new campaign, which provided the management user with access to the following features: campaign type choices such as: (1) all users (this type of campaign will send the post to all users within the system; geo-targeted (this type of campaign will allow management users to target a specific location and or predetermined radius). In addition, the management user may dynamically pull the campaign banner image from the mBaaS, or generate a new campaign banner image either by taking a new photo or using one from a photo gallery. A text input box is provided for creation of the campaign description, together with the ability to schedule a campaign for immediate delivery and or choosing a future time and date to be sent. Campaigns preferably have a required field specific to the expiration time and date. For geo-targeted campaigns, when selected, the management user may chose a specific location on the map by pinching, zooming and over sliding the dynamic map provided in the set range screen as illustrated in FIG. 2H. Users can choose to scale the range using the sliding bar to adjust the radius mileage, while the recipient status bar dynamically presents to the management user the number of recipients currently included in the chosen radius that will receive the campaign.

FIGS. 2I through 2L illustrate various user interfaces relating to customer information accessible in the management app. As illustrated in FIG. 2I, if the management user has chosen a specific location, the customer list will only display customers associated to that restaurant. If the management user has chosen a parent organization, then the customer list will display a rollup at all customers associated with that organization. In either case, a dashboard with customer analytics is displayed containing the following elements: total number of customers; total number of nearby customers determined by user specific range settings; and total number of currently checked in customers. The customer list will contain the following information: customer photo; current location and or last visit; net promoter score; total spend; and total check-ins. As illustrated by FIG. 2J, the management user has the ability to filter the customer list by the following criteria: total number of reviews; dollars spent; and number of check-ins. A customer detail screen illustrated by FIG. 2K enables the management user to view a customer detail for a specific customer that has the following elements: customer photo; customer city and state; customer net promoter score; customer total spend; customer total check-ins; the customer's published photos; and the customer's reviews. FIG. 2L illustrates the management user's ability to engage with a specific customer by built-in messaging (through the apps 111, 112 or via default text messaging or social media messages) and following or unfollowing on social media.

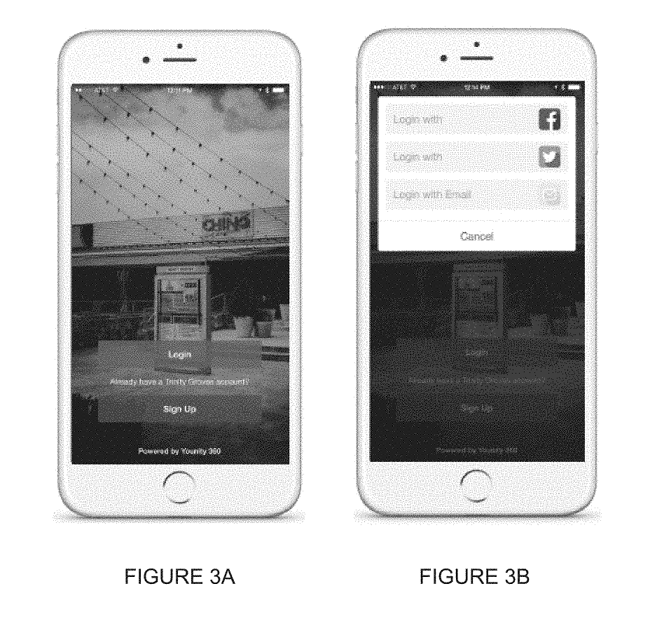

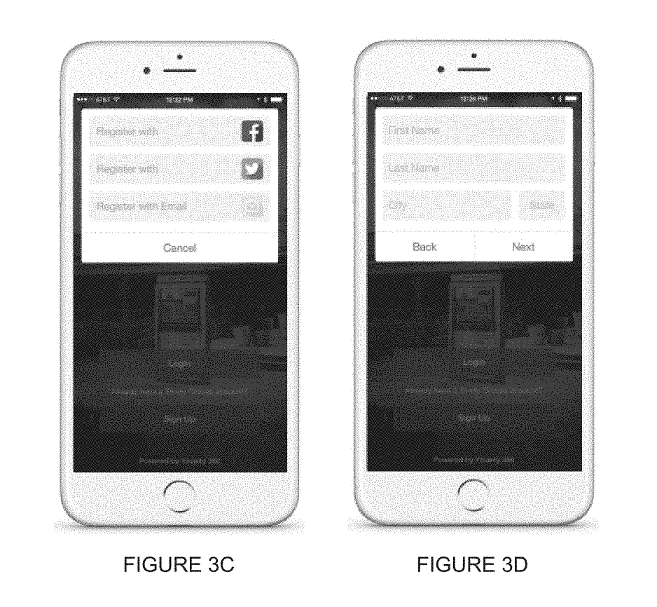

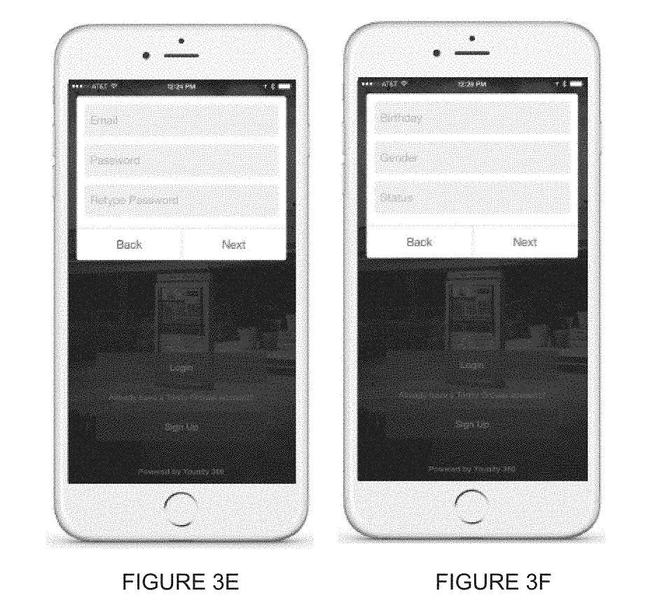

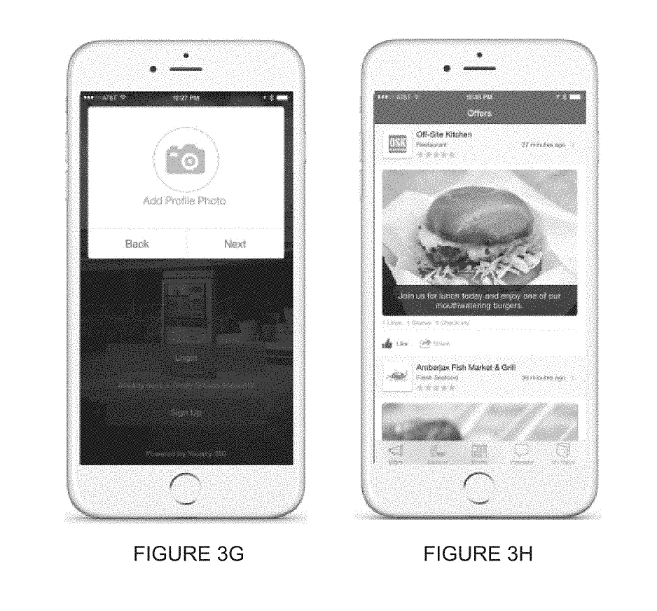

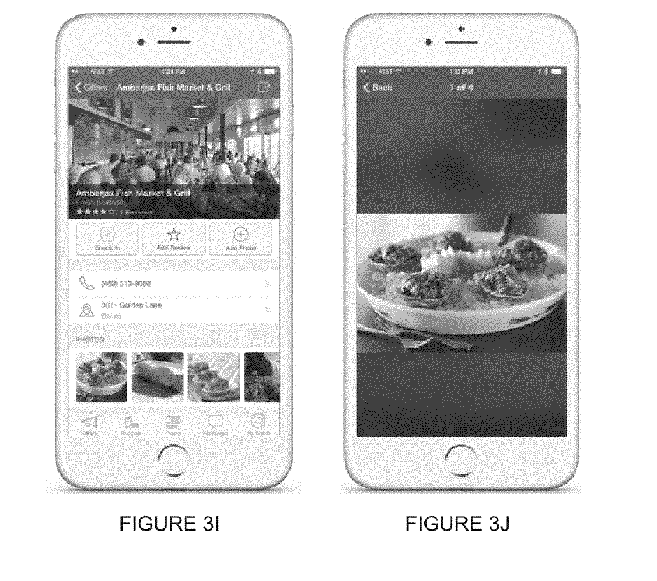

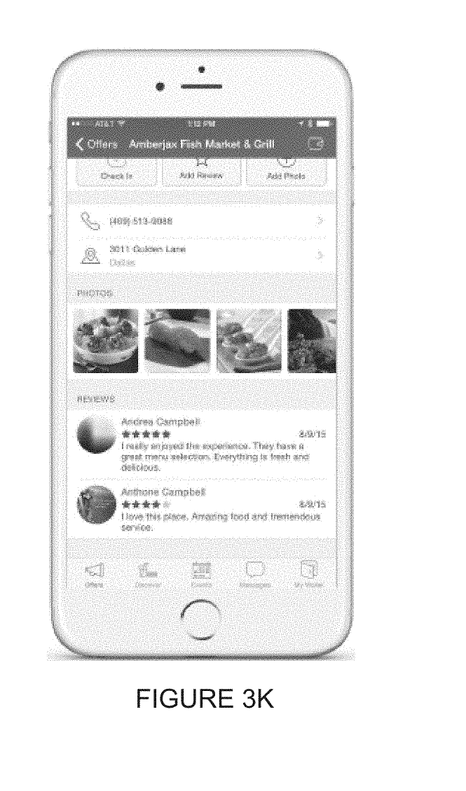

FIGS. 3A-3K depict user interfaces for a customer mobile device app facilitating customer engagement with a retail enterprise in accordance with embodiments of the present disclosure. These user interfaces for customer mobile device app 111 executing on mobile device 101 are generated during operation interacting with server 109 and/or mobile device app 112 executing on mobile device 104. FIG. 3A depicts a splash screen for the customer mobile device app 111, with a signup button and a login button. Selecting the login button produces a login screen illustrated in FIG. 3B, allowing the customer to login via Facebook, Twitter or email credentials, and providing a reset password option will send password-reset email to the customer's registered email address and a cancel button allowing user to cancel login. Selecting the signup button in the splash screen of FIG. 3A produces a signup screen illustrated in FIG. 3C, enabling the customer sign up and register with Facebook or Twitter credentials or an email address and password, and providing a cancel button allowing the customer to cancel the sign-up process.

The sign-up process runs through a series of displays illustrated in order in FIGS. 3D through 3G, with e-mail and password credentials used for the exemplary sequence shown. In the display of FIG. 3D, the customer is asked to provide their first and last names and city and state (used for location of home and work analytics), and is provided with a back button to cancel the signup process and a next button to continue the process. In the display of FIG. 3E, the customer is asked to provide their email address and desired password (and to confirm the password), and is again provided with a back button to cancel the signup process and a next button to continue the process. In the display of FIG. 3F, the customer is asked to provide their birthday, gender (male or female), status (married, single, in relationship), and is once again provided with a back button to cancel the signup process and a next button to continue the process. In the final display of the signup sequence, illustrated in FIG. 3G, the customer is asked to provide a profile photo, and provided with a back button to cancel the signup process and a next button to complete the signup process.

FIG. 3H illustrates a main screen displayed to the customer following signup and login. The display presents a tab bar application, with user controls along the bottom (in the example shown) bar to display current offers from the app's retail enterprise(s), to discover new retail enterprises associated with the app (either as members of the same parent organization or as cooperating enterprises), to display upcoming events for the app's retail enterprise(s), to display which of the app's retail enterprise(s) the customer is following, to display messages between the customer and the app's retail enterprises, and to access the customer's wallet.

FIG. 3H illustrates the main screen of the customer mobile device app with the current offers user control actuated. The offer screen includes, for offer(s) from a retail enterprise, the retail enterprise's business logo, name and type, the star rating of the retail enterprise, a time elapsed from the date of each offer sent, an offer photo and description for each of the offers as illustrated in FIG. 3I (and with the ability to enlarge the photo for a particular offer as illustrated in FIG. 3J), a number of likes, shares and check-ins associated with the offer, like and share buttons for the customer to use regarding the offer, and the profile photos of the last three other customers that checked-in for the offer as illustrated in FIG. 3K.

While not depicted, the discover user control in FIG. 3H produces a display indicating, for each retail enterprise, the retail enterprise listing by location (provided by Factual), the retail enterprise logo icon, type and rating(s), the distance from the current location, the number of reviews, and a coupon offer icon (provided by Sqoot). Each detail screen for a retail enterprise in the discover section includes a button enabling the user to return to the offers display, a button for add to the customer's wallet (which adds to wallet for receiving push notifications of new offers related to the specific restaurant). Each detail screen also includes a retail enterprise banner or custom offer photo (retail enterprises can elect to take custom photo during campaign creation or leave blank for default banner image), the retail enterprise name, business type, star ratings and number of reviews. A check-in button allows users to manually check-in at the retail enterprise, with the system validates location to allow up to (for example) a 1 mile radius. An add review button and an add photo button are displayed, together with direct dial and address (including map and driving directions) information. A menu button allows access to a menu, to which the retail enterprise may dynamical add menu items from management app. Photos may be viewed as either a list or individually full screen, with submitter profile photo and user comments. The reviews preferably include all user submitter reviews. The checked-in display provides a horizontal list of all customer that have location awareness turned on and that have checked-in at the retail enterprise.

The retail enterprise events screen (also not depicted) displays the retail enterprise logo and name, the event name and event start and end dates and times. A detail screen for each event includes: an event banner image; RSVP, like and share buttons; numbers of likes and RSVP's; the ability to view RSVP's; and the event description and start and end dates and times.

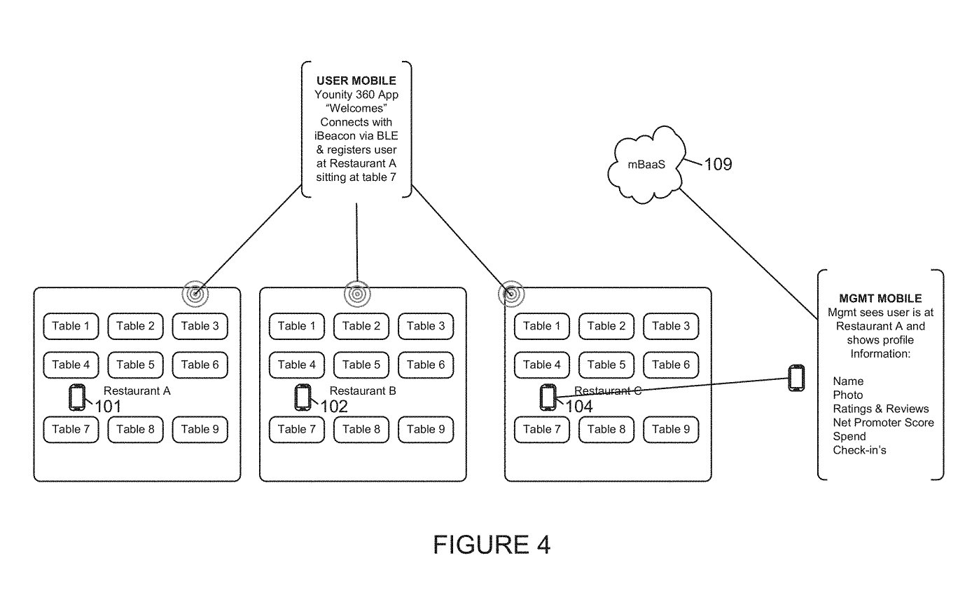

FIG. 4 is a diagram illustrating a beacon process employed for customer and management mobile device apps facilitating customer engagement with a retail enterprise in accordance with embodiments of the present disclosure. The system components depicted in FIG. 1 are employed, but to illustrate the flexibility of the customer engagement platform, three different retail establishments are illustrated for this embodiment: restaurant A, restaurant B and restaurant C. FIG. 4 is not meant to indicate any particular proximity of the three restaurants, which may have adjoining service areas or alternatively may be spread among different locations within a city or other geographic region. In this embodiment, restaurants A, B and C are all part of the same parent (e.g., management) organization.

Each restaurant A, B and C in FIG. 4 has its own small area connectivity system (Bluetooth LE beacons) configured to cover the service area of the respective restaurant and, preferably, an entry area encompassing a range of up to approximately 20-50 meters from the restaurant's entrance (a range that may be specific to each restaurant location, taking into account proximity of associated restaurants also operating small area connectivity systems). Each of restaurants A, B and C thus include beacon access points such as those illustrated (105 and 106) in FIG. 1, with the locations and power settings configured to provide coverage of the service (including business office) area and entry area of the respective restaurants. The coverages of the three small area connectivity systems preferably do not overlap.

In the beacon process illustrated in FIG. 4, a customer associated with customer mobile device 101 executing (e.g., in the background) customer mobile device app 111 enters restaurant A. Once the customer mobile device 101 enters the coverage of restaurant A's small area connectivity system, the customer mobile device app 111 causes the customer mobile device 101 to discover and connect to the small area connectivity system of restaurant A. Upon connection of customer mobile device 101 with restaurant A's small area connectivity system (or, optionally, following some predetermined time period or other connectivity requirement designed to ensure that the customer did not simply walk past the entrance), server 109 receives an indication of such connection and registers the respective customer as located in restaurant A and (for example) seated at table 7. In response to the customer (specifically, the customer's mobile device 101 executing customer mobile device app 111) being registered as having entered restaurant A by server 109, the server 109 sends a notification to (for example) the management mobile device app 112 executing in retail enterprise mobile device 104. In the example shown, retail enterprise mobile device 104 is shown as located inside restaurant C to illustrate the flexibility of the customer engagement platform. Of course, the notification could be sent to the retail enterprise mobile device 104 even if it were located in restaurants A or B (or not in any of restaurants A, B or C), and multiple retail enterprise mobile devices (e.g. mobile device 103 not shown in FIG. 4, as well as mobile device 104) may receive the notification or variants of the notification.

Receipt of the notification(s) of the customer's mobile device connection with the small area connectivity system of restaurant A at one or more mobile devices used by employees of that restaurant can include various items of information and trigger a number of different activities. As illustrated in FIG. 4, the notification to management mobile device 104 can include the customer's name, photo, ratings and reviews for restaurant A, net promoter score, total spend, and total check-ins. This information may be used by the restaurant manager to decide whether to prioritize seating of the customer or make a special, private offer to the customer, based on past spending or promotion by the customer at restaurant A (or across restaurants A, B and C). As described earlier, the customer name and photo may be included in a notification sent to the restaurant's mobile device used at the host stand, to allow the host(ess) to greet the customer by name. A similar immediate notification may be sent to the restaurant's mobile device carried by the head chef, optionally qualified based on whether the customer is considered a VIP.

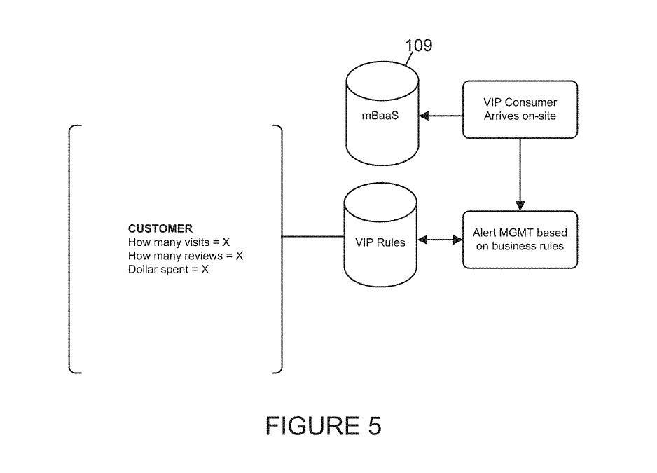

FIG. 5 is a diagram illustrating a VIP notification process employed for management mobile device apps facilitating customer engagement with a retail enterprise in accordance with embodiments of the present disclosure. When an actual or potential VIP customer arrives on site at a retail enterprise, the server 109 is notified by the customer mobile device app 111 executing on the customer mobile device 101. The status of a customer as a VIP may be determined by customer mobile device app 111 based on a profile attribute not visible or accessible to the customer, but only accessible (for both reading and setting) by the customer mobile device app 111. The arrival of the VIP customer may be determined based on connection of the customer's mobile device 101 with the retail enterprise's small area connectivity system as discussed above. Alternatively, the VIP customer's arrival may be determined based on the customer manually checking in using the customer mobile device app 111, or based on GPS coordinates for the current location of the customer's mobile device 101 being determined by the customer mobile device app 111 to be within a predefined range of distances from the GPS coordinates of the retail enterprise.

As illustrated in FIG. 5, the VIP customer arrival may result in a notification to a management mobile device app 112. The notification may be direct from the customer mobile device app 111 to the management mobile device app 112 via the retail enterprise's small area connectivity system. Alternatively, the notification may be routed through the server 109. As shown, VIP rules may be accessed to verify the customer's VIP status, which rules require (for the example shown) a predetermined number of prior visits by the customer, a predetermined number of reviews by the customer, a predetermined number of total dollars spent (over a given recent time period) by the customer, or some permutation of those criteria. In general, some combination of the customer's ratings and reviews, net promoter score, total spend, total check-ins, the number of associated restaurants that the customer is following may influence special (VIP) status accorded to the customer for various purposes described herein.

Referring back to FIG. 4, during the customer's dining experience (i.e., while the customer's mobile device remains connected to the restaurant's small area connectivity system), various other triggers may be established and employed to facilitate customer engagement. Some of the established triggers may be based on notifications to the server by the restaurant's staff, using a restaurant mobile device app. For example, once a hostess indicates, using a restaurant mobile device app, that the customer has been seated at a particular table, a timer may be set and, upon expiration, a notification sent to the restaurant's mobile device carried by the manager or head chef, to prompt the manager or head chef to (a) stop by that table and interact personally with the customer, (b) send an amuse-bouche appetizer to the customer's table, or (c) send a message regarding a special or off-menu offer to that customer via the customer mobile device app 111 executing on the customer mobile device 101. As another example, once the customer's order has been entered by a waiter or waitress, using a restaurant mobile device app, a notification (optionally qualified based on whether the customer is considered a VIP) may be sent to the restaurant's mobile device carried by the manager or head chef, to allow the manager or head chef to send a sample of wine complimenting the foods ordered to the customer's table. As still another example, once the waiter or waitress indicates, using a restaurant mobile device app, that the entrée dishes have been cleared from the customer's table, a notification (optionally qualified based on whether the customer is considered a VIP or on an amount of the check for the customer's order) may be sent to the restaurant's mobile device carried by the manager or head chef, to allow the manager or head chef to decide whether to send a complimentary dessert to the customer.

Some of the established triggers mentioned above may be based on notifications to the server by the customer's mobile device app 111 while the customer's mobile device 101 is connected to the restaurant's small area connectivity system. For example, if the customer manually checks-in (assuming that automatic check-in upon arrival is not enabled) or posts a review using the customer mobile device app 111 while the customer's mobile device 101 is connected to the restaurant's small area connectivity system, notifications may be sent to the restaurant staff in real time to allow for personal visits to the customer's table, complimentary appetizers or deserts, etc.—that is, any of the types of rewards or personalized customer service described herein.

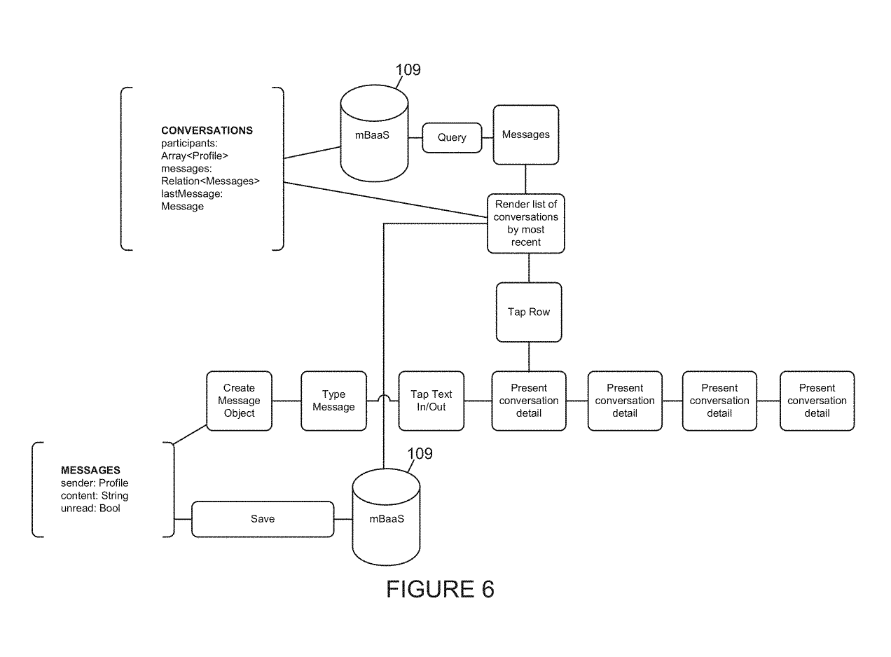

FIG. 6 is a diagram illustrating a messaging process employed between the customer and management mobile device apps facilitating customer engagement with a retail enterprise in accordance with embodiments of the present disclosure. While the messaging process may be used when one or both of the customer or the restaurant employee are not at the restaurant location, the messaging may also be used during the customer's dining experience to facilitate customer engagement (e.g., by personal messages from the head chef or special offers as described above).

When messaging is initiated in either the customer mobile device app 111 or the management mobile device app 112, a query to the server 109 for conversations as associated information, to render a list of the conversations in order of most recent to oldest. When the user taps a row within the conversation list, the selected conversation is presented in similar time order. When a text message creation control is actuated and content for a text message entered by the user, a message object is created (with suitable associated parameters) to be communicated to the recipient and saved to the server 109 for both the sender and recipient.

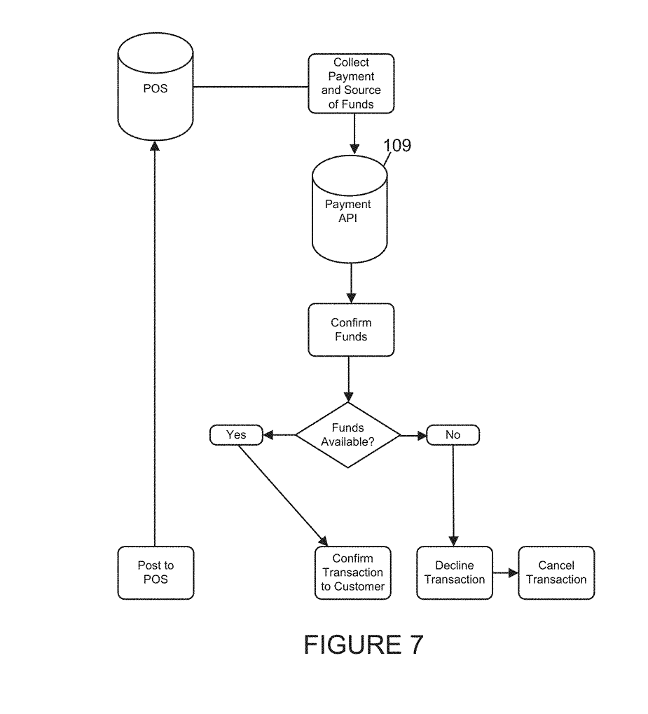

FIG. 7 is a diagram illustrating a mobile payment process employed for the customer mobile device app facilitating customer engagement with a retail enterprise in accordance with embodiments of the present disclosure. Once a waitress or waiter closes a customer's tab in a management mobile device app 112 or similar device having bill calculation functionality, the check for a customer's order may be presented electronically within the customer mobile device app 111, or physically with a bar code that may be scanned by the customer mobile device 101 to bring up an electronic check. The customer may pay using the wallet function in the customer mobile device app 111. Payment information (credit card, Apple pay, etc.) for the source of funds is collected within the customer mobile device app 111 (if not already collected and stored in the wallet), and processed by transmission through a payment gateway API to confirm availability of funds. If insufficient funds are available, the transaction will be declined and canceled. When sufficient funds are available, the transaction is confirmed to the customer within the customer mobile device app 111 and concurrently posted to a point-of-sale (POS) account.

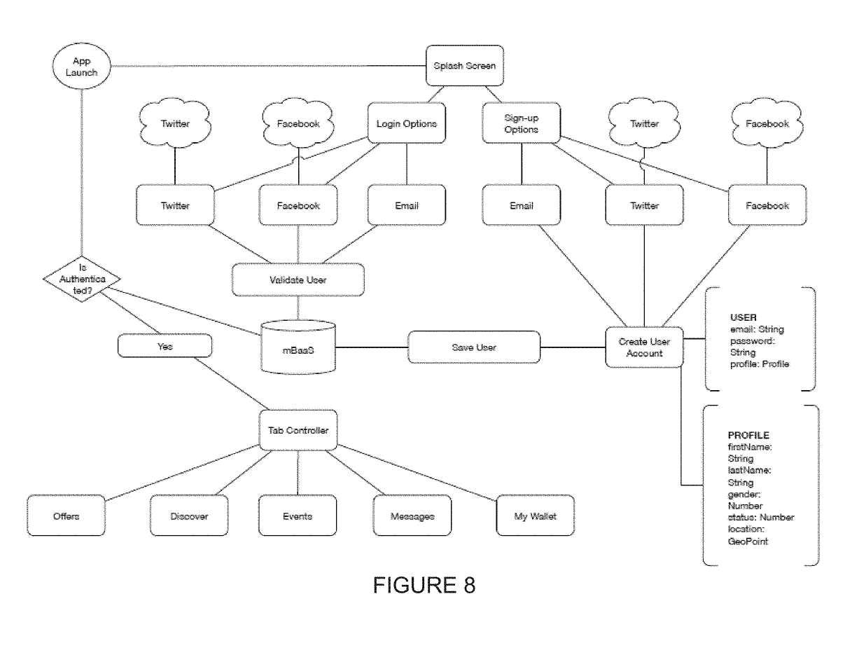

FIG. 8 is a diagram illustrating a splash and login process employed for the customer mobile device app facilitating customer engagement with a retail enterprise in accordance with embodiments of the present disclosure. The process depicted in FIG. 8 has generally been described above in connection with FIGS. 3A through 3G. When the customer mobile device app 111 is launched (i.e., either for the first time or when not already executing in the background), the splash screen is displayed offering the options of signing up or logging in. The sign-up options allow creation of an account using Facebook or Twitter credentials or an e-mail address and password, where the user profile includes the parameters described above. The login option allows use of Facebook or Twitter credentials or an e-mail address and password (either entered for the current use or previously stored), and validates the user through server 109. Once validated, the user is presented by a tab controller with the offers, discover, events, messages and wallet tabs previously described.

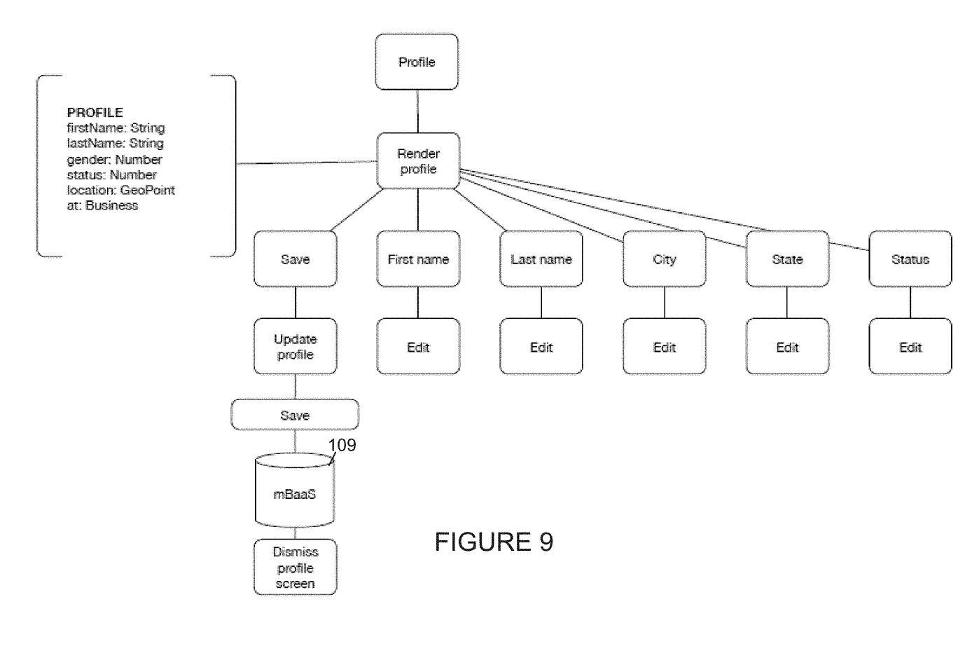

FIG. 9 is a diagram illustrating a user profile edit process employed for the customer mobile device app facilitating customer engagement with a retail enterprise in accordance with embodiments of the present disclosure. When the customer actuates a profile edit control in the customer mobile device app 111, the profile is rendered and displayed with parameters (first and last name, city and state, status) displayed as editable objects. The customer can edits the profile fields and select save, which updates the profile stored for that customer in the server 109 and/or associated data store 110, and then dismisses the profile edit display.

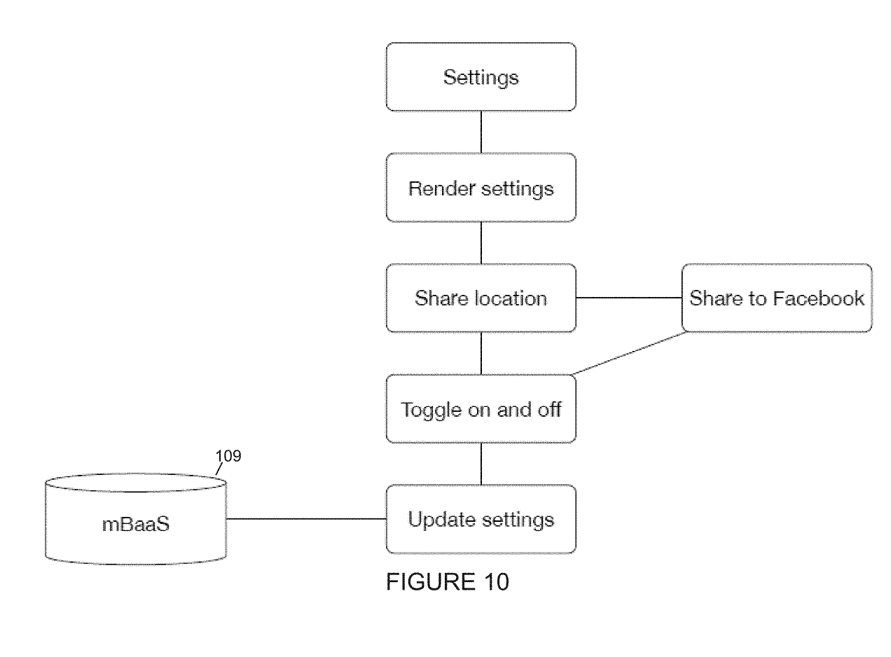

FIG. 10 is a diagram illustrating a user settings edit process employed for the customer mobile device app facilitating customer engagement with a retail enterprise in accordance with embodiments of the present disclosure. When the customer actuates a settings edit control in the customer mobile device app 111, the current settings are rendered and displayed with controls allowing the user to toggle on or off the share location (e.g., automatic check-in) function and the share (location) with Facebook function, which are appropriately updated and stored for that customer in the server 109 and/or associated data store 110, with the settings edit display then being dismissed.

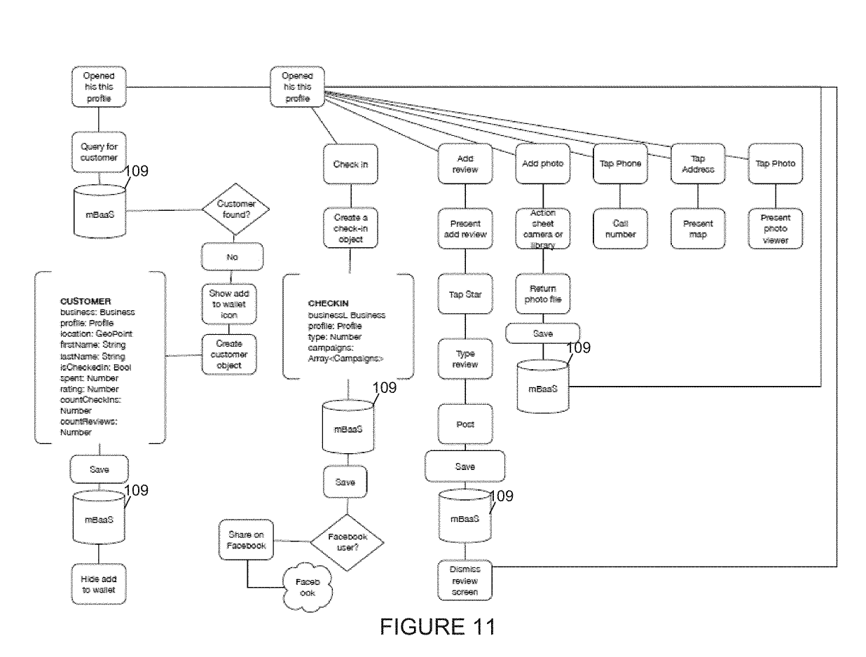

FIG. 11 is a diagram illustrating a business profile access process employed for the customer mobile device app facilitating customer engagement with a retail enterprise in accordance with embodiments of the present disclosure. When the customer attempts to access a particular retail enterprise (restaurant) profile using the customer mobile device app 111, the app checks to determine of the customer has previously associated with that restaurant by querying for the customer in the restaurant's records using server 109 and/or data store 110. If the customer is not already associated with the restaurant, a pop-up offering to add the restaurant to the customer's wallet is displayed in the customer mobile device app 111. If selected, a customer object for the customer is created and saved to the restaurant's records in server 109 and/or data store 110, and the pop-up is hidden.

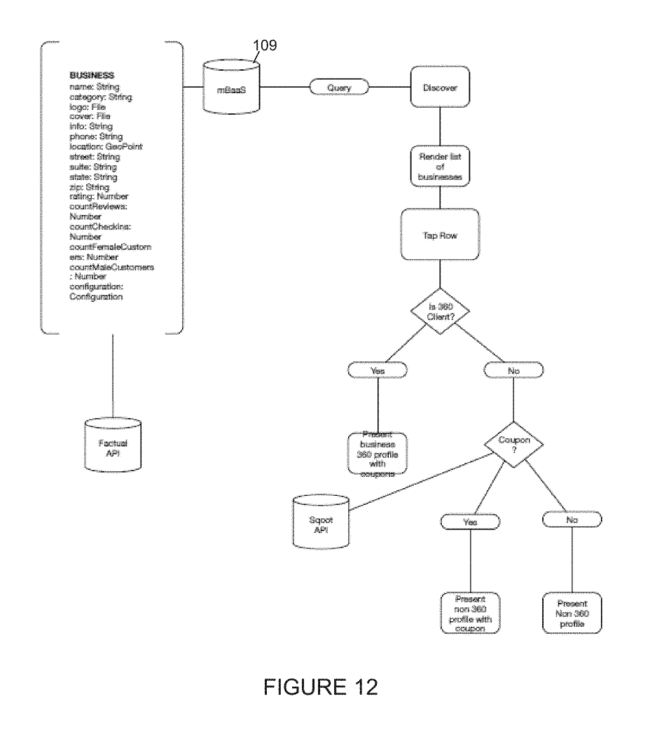

FIG. 12 is a diagram illustrating a discover process employed for the customer mobile device app facilitating customer engagement with a retail enterprise in accordance with embodiments of the present disclosure. When the user actuates the discover tab of the user interface, the server 19 and/or data store 110 are queried, together with information from alternative databases such as Factual, and a list of retail enterprises is rendered and displayed. When the user taps a row for a particular retail enterprise in the displayed list, a determination is made at server 109 regarding whether the selected retail enterprise is one for which the mobile device app has been promulgated. If so, the retail enterprise's profile is retrieved from the server 109 and/or data store 110 and displayed, optionally together with one or more coupons. If the selected retail enterprise is not one for which the mobile device app has been promulgated, a query as to whether any coupon is available is made to an external commercial database such as Sqoot. If a coupon is available, the retail enterprise profile is displayed together with the coupon; otherwise, the retail enterprise profile is displayed without any coupon.

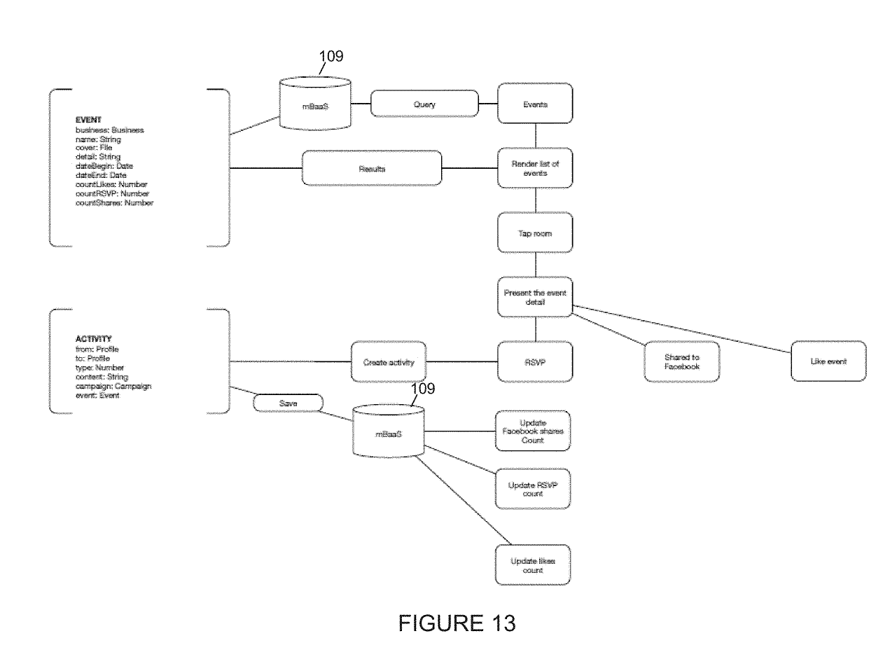

FIG. 13 is a diagram illustrating an events process employed for the customer mobile device app facilitating customer engagement with a retail enterprise in accordance with embodiments of the present disclosure. When the customer operating the customer mobile device app 111 selects the events dashboard, a query of the events stored in server 109 and/or data store 110 is made and the results are rendered and displayed. When a particular event or retail enterprise is tapped, the event details are presented together with controls to like the event, share the event to Facebook, or RSVP to the event. When the customer RSVPs, an activity to update the server 109 and/or data store 110 is initiated, which updates the likes count, Facebook shared count, and RSVP count.

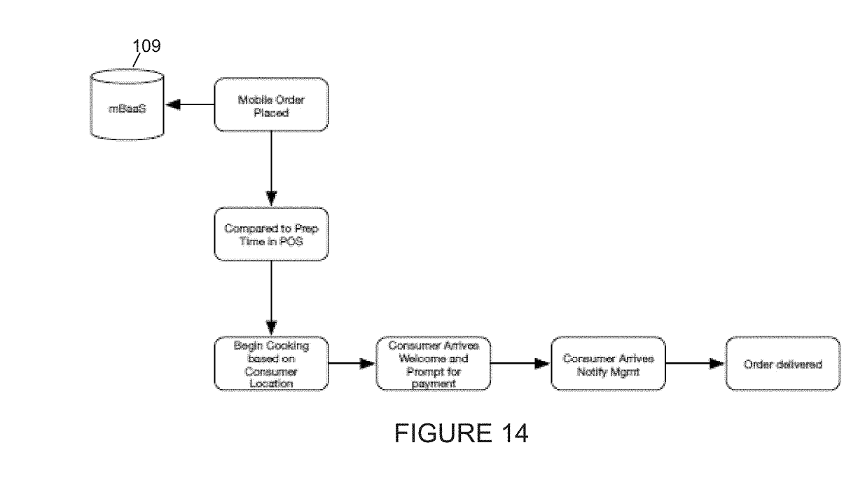

FIG. 14 is a diagram illustrating a to-go order process employed for the customer mobile device app facilitating customer engagement with a retail enterprise in accordance with embodiments of the present disclosure. When a to-go order is placed, either by telephone call or through the customer mobile device app, the customer is looked up in the server 109 and/or data store 110. The customer's location is identified and preparation time is determined based on the estimated time for the customer to reach the restaurant. Food preparation is initiated based on the determined estimated time of customer arrival. When the customer arrival is detected (e.g., in one of the manners described above), the customer mobile device app 111 displays a welcome to the customer and prompts the customer to initiate payment, while the management mobile device app 112 is notified of the customer's arrival and the order is delivered.

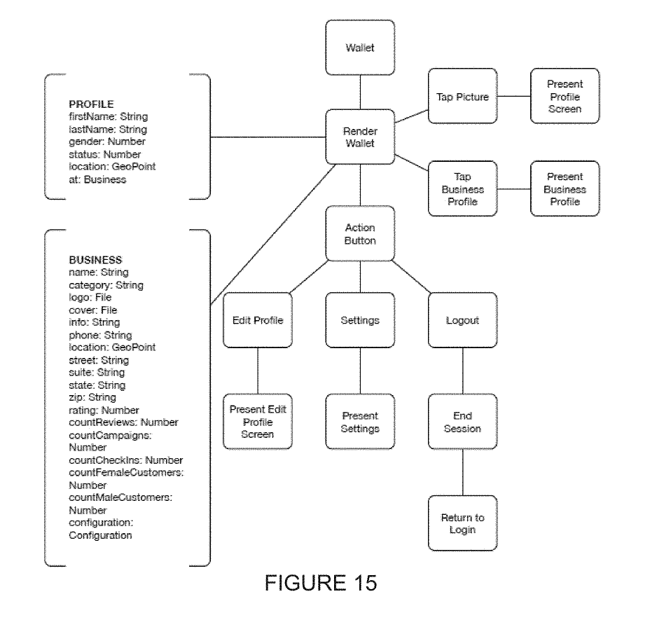

FIG. 15 is a diagram illustrating a wallet process employed for the customer mobile device app facilitating customer engagement with a retail enterprise in accordance with embodiments of the present disclosure. When the wallet tab of the customer mobile device app 111 is actuated by the customer, the wallet is rendered with the customer's picture and, if appropriate) a link to the retail enterprise profile of the retail enterprise requesting payment. If the customer picture or the retail enterprise logo is tapped, the respective profile is displayed. If an edit profile, settings, or logout action button is actuated, the respective action is initiated.

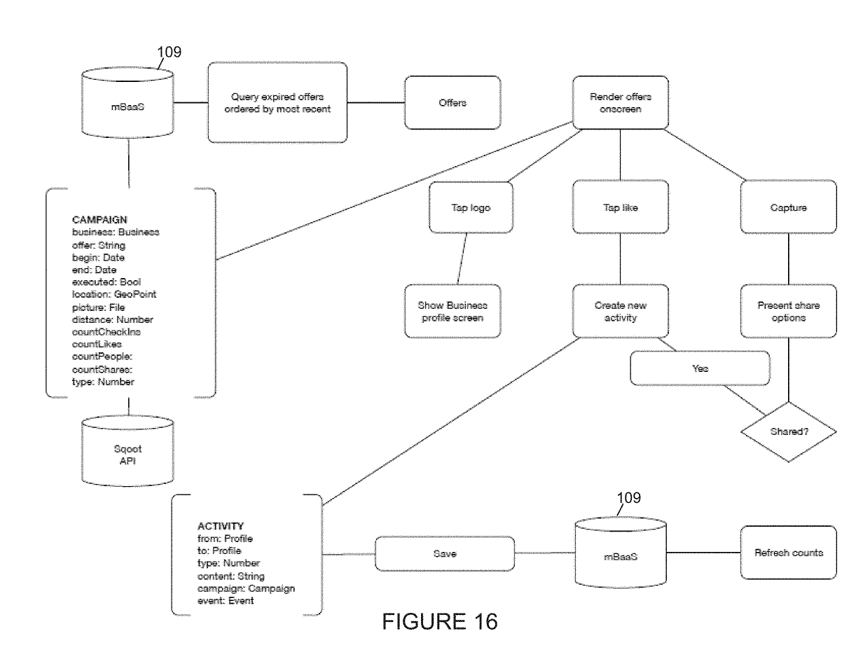

FIG. 16 is a diagram illustrating an offers process employed for the customer mobile device app facilitating customer engagement with a retail enterprise in accordance with embodiments of the present disclosure. When the customer actuates the offers tab in the customer mobile device app 111, campaigns are optionally queried from either server 109 and/or data store 110 or a commercial database such as Sqoot, with offers ordered by most recent, rendered, and displayed to the customer in the customer mobile device app 111. The customer may tap the retail enterprise logo for an offer to show the profile of the retail enterprise making the offer. If the customer taps either a like control or a capture control associated with the offer, share options are presented (if the capture control was tapped) and, if liked or shared, a new activity is created and saved to the server 109 and/or data store 110. Like and share counts are then updated for the customer.

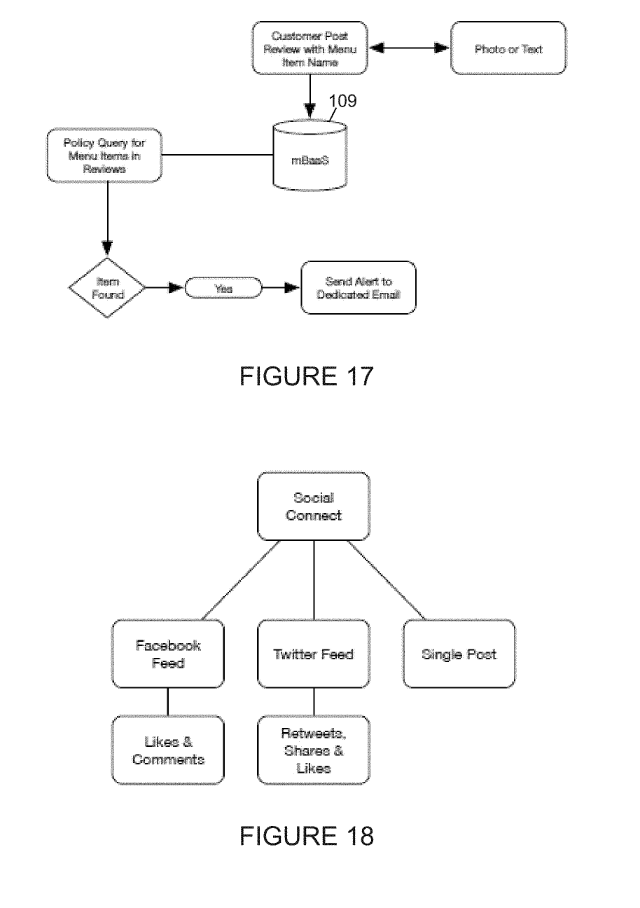

FIG. 17 is a diagram illustrating a review process employed for the customer mobile device app facilitating customer engagement with a retail enterprise in accordance with embodiments of the present disclosure. When the customer makes a review of a menu item in the customer mobile device app 111, using a photo or text for the menu item, the server and/or data store 110 are checked for the menu item and, if found, an alert regarding the review is sent to a dedicated email or email list.

FIG. 18 is a diagram illustrating a social connect process employed for the customer mobile device app facilitating customer engagement with a retail enterprise in accordance with embodiments of the present disclosure. The customer using the customer mobile device app 111 may use the app to concurrently post to his or her Facebook feed (including likes and comments) and Twitter feed (including retweets, shares and likes), or to make single posts to one or the other, or to a timeline or feed for the retail enterprise.

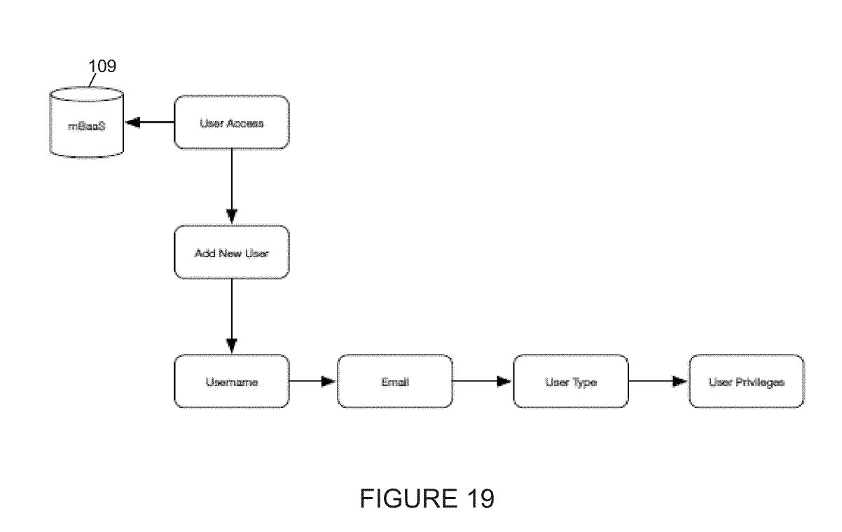

FIG. 19 is a diagram illustrating a management user access setup process employed for the management mobile device app facilitating customer engagement with a retail enterprise in accordance with embodiments of the present disclosure. When the user access process is initiated, the server 109 and/or data store 110 are updated based on the new user being added, including the username, email, user type and user privileges.

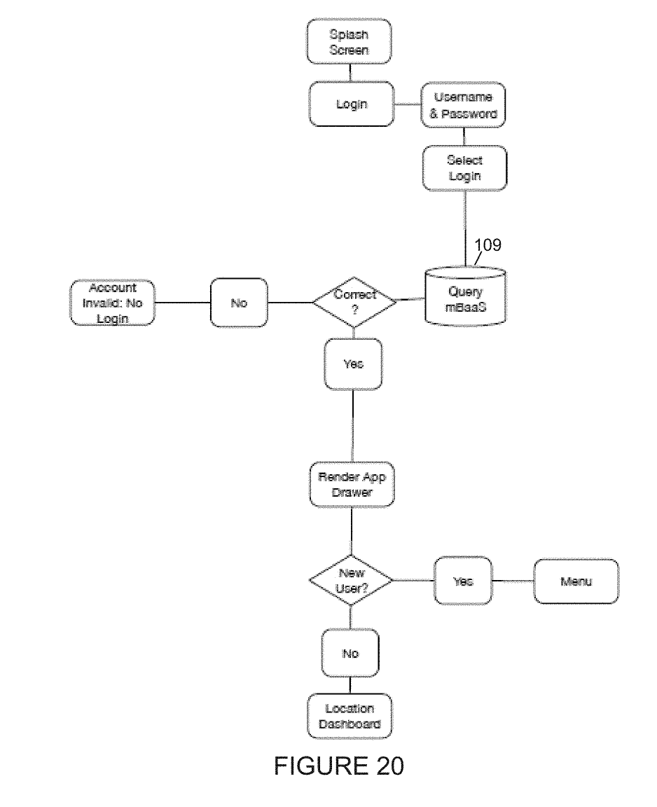

FIG. 20 is a diagram illustrating a management user login process employed for the management mobile device app facilitating customer engagement with a retail enterprise in accordance with embodiments of the present disclosure. From a splash screen for the management mobile device app 112, actuation of a login user control prompts the user for entry of a username and password, which are then authenticated with the server 109 and/or data store 110. If valid credentials have not been presented, the login process is discontinued. If valid credentials have been presented, a determination of whether the user is new is made. Users logging in for the first time are taken to a menu for completing a profile. Returning users are taken to a location dashboard for the retail enterprise associated with the user.

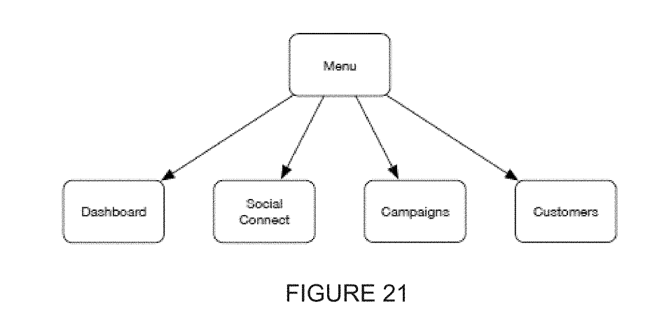

FIG. 21 is a diagram illustrating a management user control process employed for the management mobile device app facilitating customer engagement with a retail enterprise in accordance with embodiments of the present disclosure. Once logged in, the management user operating the management mobile device app 112 is presented with a menu including a dashboard option, a social contact option, a campaigns option, and a customers option.

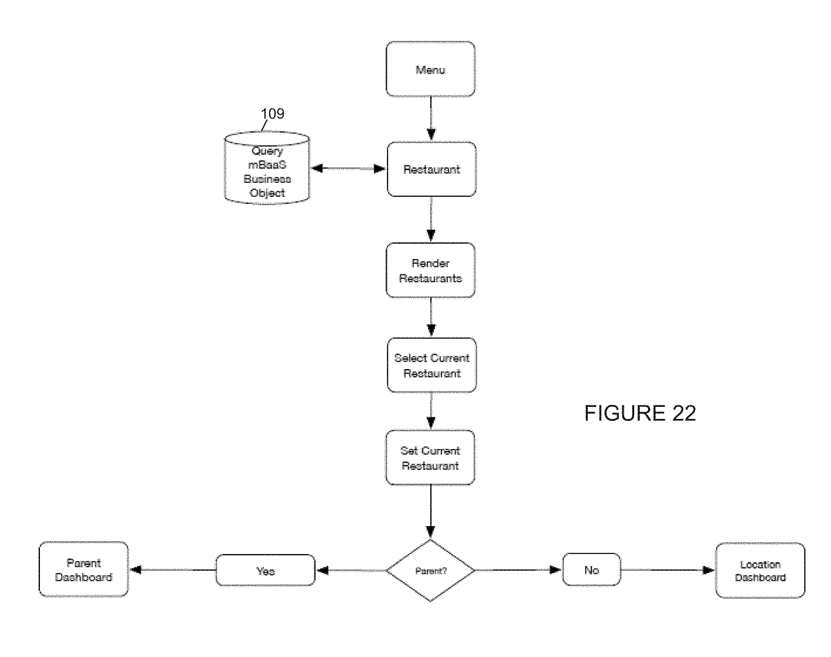

FIG. 22 is a diagram illustrating a management location selection process employed for the management mobile device app facilitating customer engagement with a retail enterprise in accordance with embodiments of the present disclosure. When the management user operating the management mobile device app 112 actuates a location control, the server 109 and/or the data store 110 are queried to determine a list of restaurants (including the parent organization), which is rendered and displayed to the user. When a location on the displayed list is selected, the selected location is set as a current location and, if the parent organization was selected, the parent dashboard is displayed but otherwise the selected location dashboard is displayed.

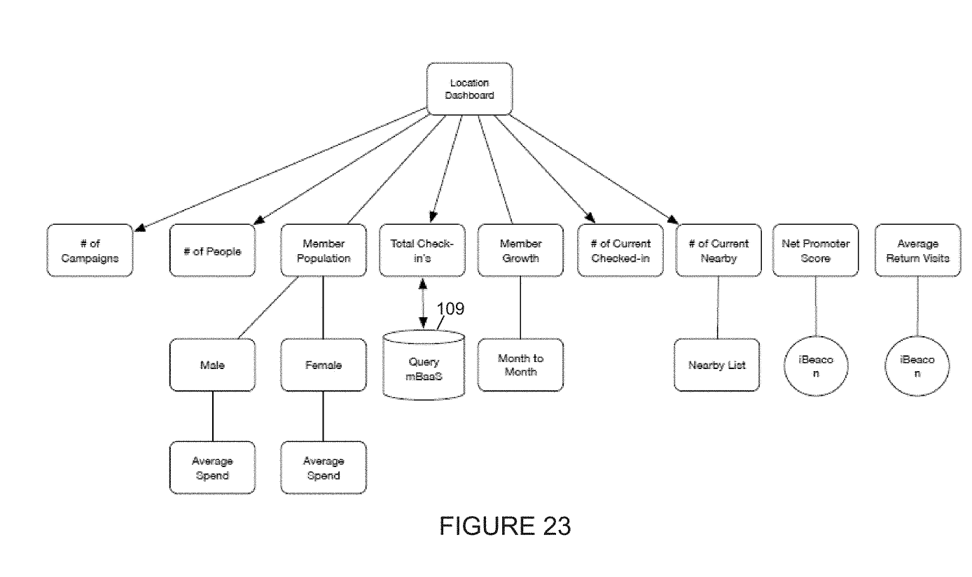

FIG. 23 is a diagram illustrating a management location dashboard process employed for the management mobile device app facilitating customer engagement with a retail enterprise in accordance with embodiments of the present disclosure. When the management user operating the management mobile device app 112 selects the user dashboard for a specific location, the user can view—for that location—the number of campaigns, the number of customers served, the registered customer population including breakdown by gender and average spend for each, the total check-ins by registered customers, member growth including breakdown by month, the number of current check-ins by registered customers, the number of registered customers that are currently nearby (within a predefined or adjustable radius of, but not at, the retail enterprise) and a nearby list, the net promotor score for each registered customer currently connected to the retail enterprise small enterprise connectivity system, and the average return visits for each registered customer currently connected to the retail enterprise small enterprise connectivity system.

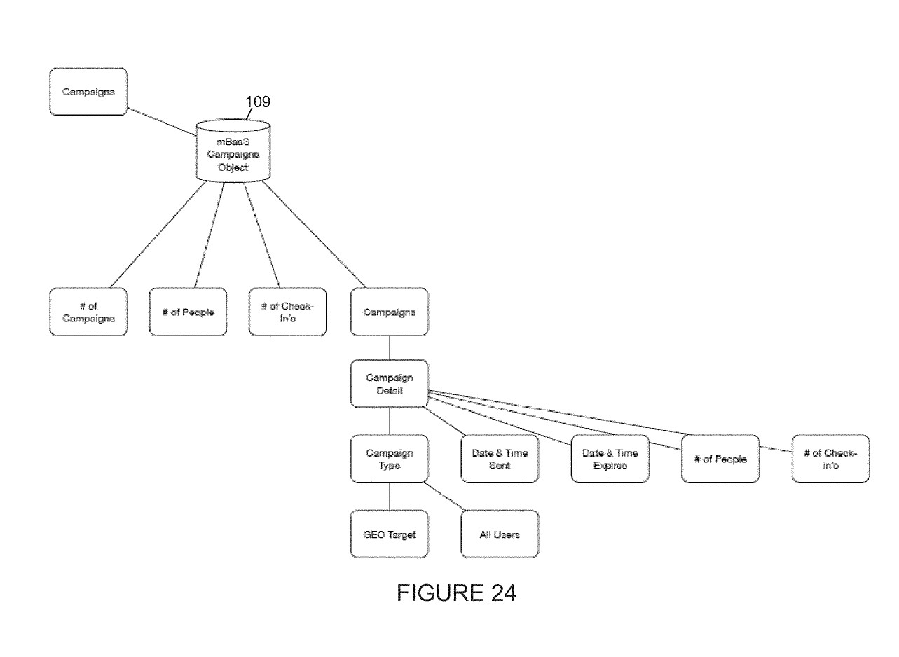

FIG. 24 is a diagram illustrating a management campaigns dashboard process employed for the management mobile device app facilitating customer engagement with a retail enterprise in accordance with embodiments of the present disclosure. When the management user operating the management mobile device app 112 selects the campaigns dashboard, the user can view the number of campaigns, the number of customers (and potential customers) to which the campaigns were sent), and the number of check-ins for the campaigns. For each campaign, the user can view: campaign details including date and time when the campaign was sent and when it expires, the number of customers or potential customers to which the campaign was sent, and the number of check-ins for that campaign; campaign type including all users associated with the campaign; and the geographic target for the campaign.

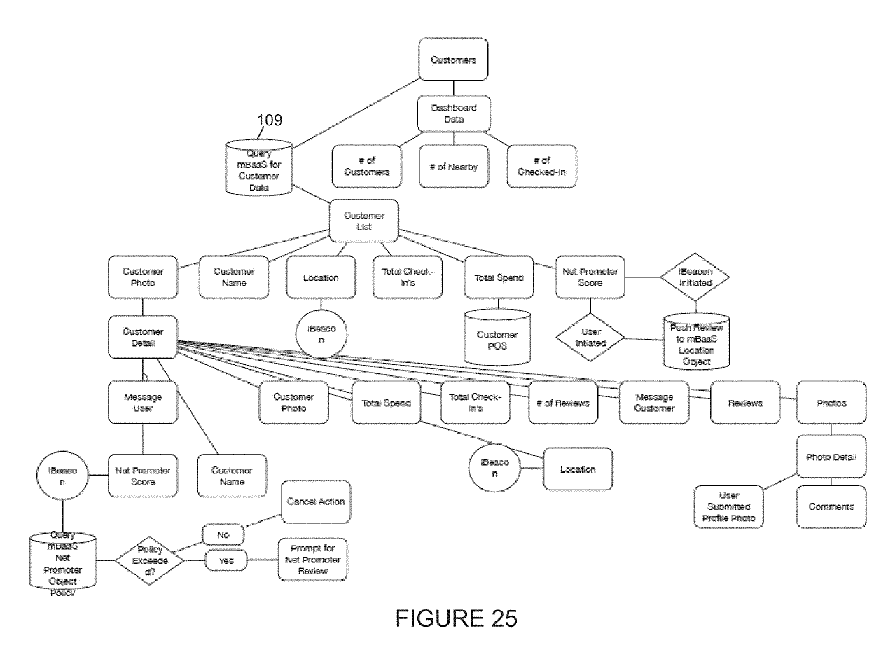

FIG. 25 is a diagram illustrating a management customer dashboard process employed for the management mobile device app facilitating customer engagement with a retail enterprise in accordance with embodiments of the present disclosure. When the management user operating the management mobile device app 112 selects the customer dashboard, the user can view the number of registered customers, the number of registered customers nearby (within a predefined or adjustable radius of, but not at, the retail enterprise), and the number of registered customer that are checked-in. A list of registered customers included the customer's profile photo, name, location (including whether connected to the retail enterprise small area connectivity system), total spend, and net promoter score including user-initiated and enterprise-prompted reviews and promotions). From a list of registered customers (including profile photo), the user can select a customer photo to view customer details including: name, photo, total spend, number of reviews, and location (including whether connected to a retail enterprise small area connectivity system), and can also initiate messaging with the customer, access the customer's reviews, view photos of the customer taken at the retail enterprise or submitted by the customer, and review comments on any of those photos. Details of the customer's net promoter score can be accessed, relative to a policy for rewarding promoters.

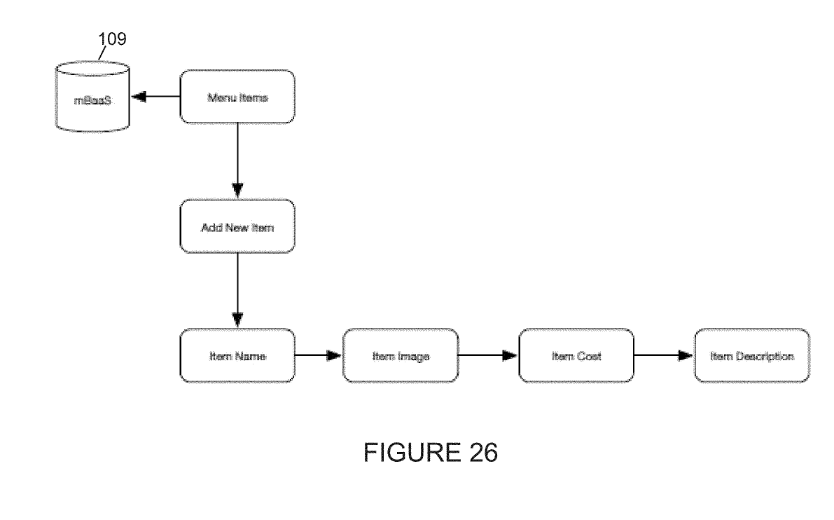

FIG. 26 is a diagram illustrating a management dynamic menu dashboard process employed for the management mobile device app facilitating customer engagement with a retail enterprise in accordance with embodiments of the present disclosure. When the management user operating the management mobile device app 112 selects the menu items, the user can add a new item including item name, image, cost and description.

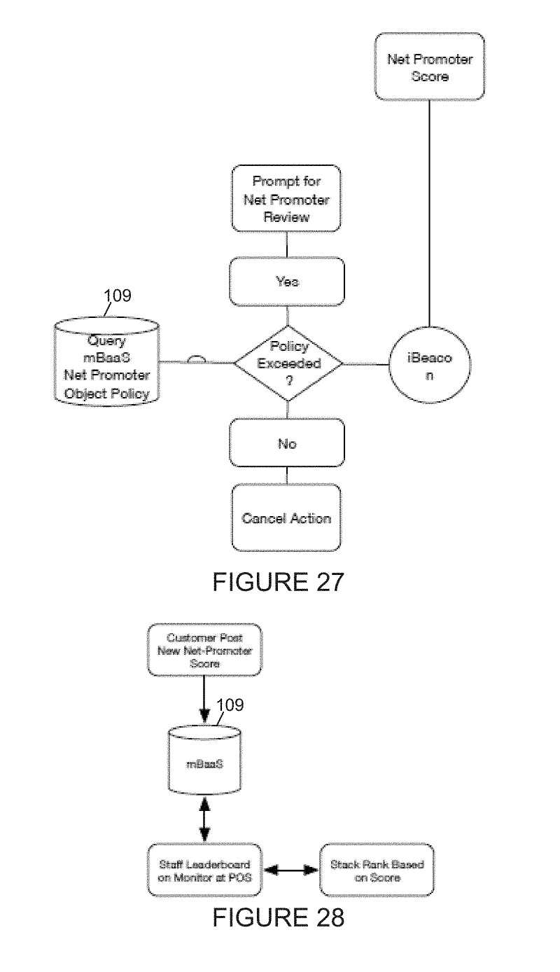

FIGS. 27 and 28 are diagrams illustrating counterparts for a net promoter score process employed for the customer and management mobile device apps facilitating customer engagement with a retail enterprise in accordance with embodiments of the present disclosure. When the customer's mobile device connects to the retail enterprise small area connectivity system, a check is made as to whether the policy for reviews by the customer to obtain rewards has been exceeded. If not, the customer mobile device app 111 prompts the customer to review the retail enterprise. When a customer posts a review, the leaderboard is updated and rank-ordered by net promoter score for access by the management mobile device app 112.

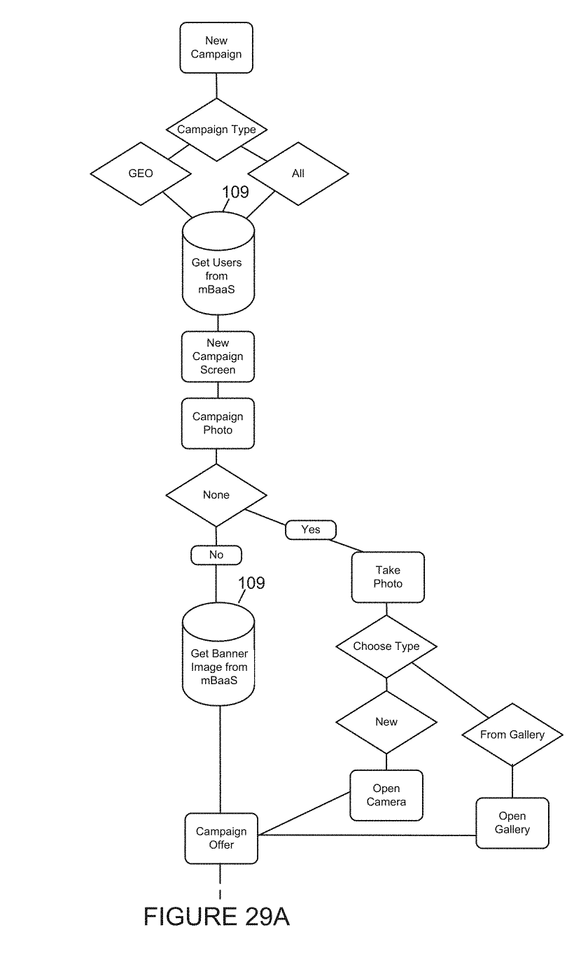

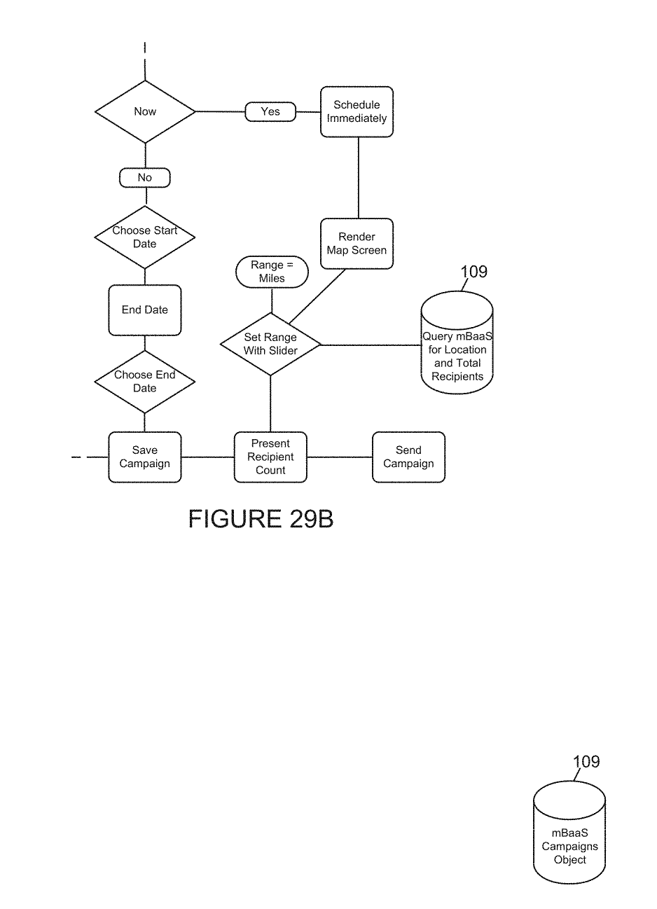

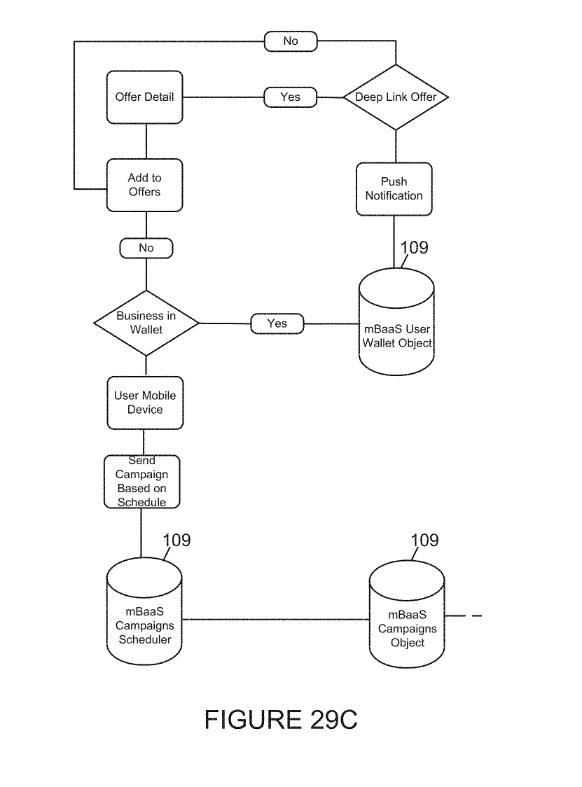

FIGS. 29A-29C are a diagram illustrating a management new campaign process employed for the customer and management mobile device apps facilitating customer engagement with a retail enterprise in accordance with embodiments of the present disclosure. When the management user operating the management mobile device app 112 (or a counterpart function on a laptop or desktop system) uses the campaign function, the user is prompted for a campaign type, either all registered customers and potential customers or a geographically-targeted subset of the registered and potential customers. If a new campaign is being started, the user is prompted to either take a photo or select a photo from a gallery for the campaign banner image to be inserted into the campaign offer. If the campaign offer is new, the user is prompted to either set the campaign for an immediate start and set the campaign range with a slider to see the recipient count, or enter start and end dates to be saved and set the campaign range with a slider to see the recipient count.

Campaigns are saved in server 109 and/or data store 110 as objects and are sent to customers based on the campaign schedule by a campaign scheduler executing on server 109 and accessing campaign start dates for the campaign objects saved in data store 110. The campaigns are sent to the customer mobile device app 111 based on the respective campaign schedule. Optionally, if the retail enterprise for a campaign newly received at the customer mobile device app 111 is already in the customer's wallet, the campaign is automatically added to the customer's wallet and a push notification of the campaign is sent to create a visible prompt for associated offers in the customer mobile device app 111. If the enterprise for a campaign newly received at the customer mobile device app 111 is already in the customer's wallet, the campaign and its associated offers are added to the offers accessible in the customer mobile device app 111, together with offer details that may be accessed by selecting the offer to view.

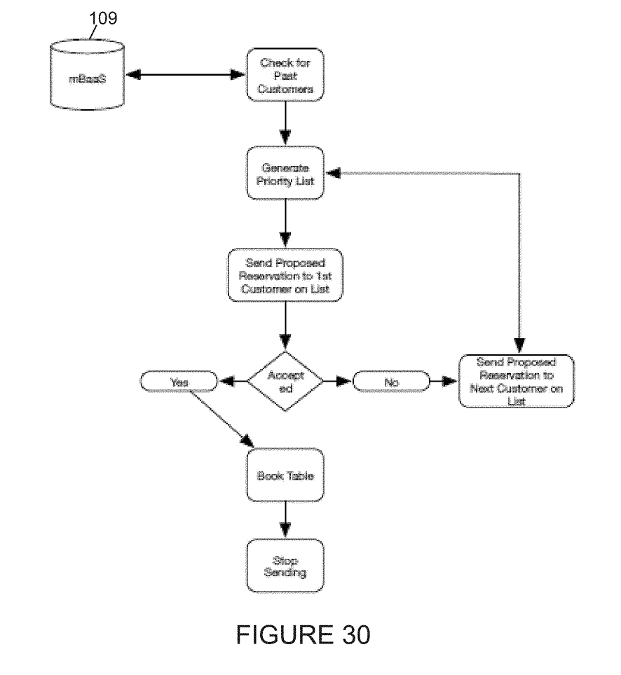

FIG. 30 is a diagram illustrating a management past customers process employed for the customer and management mobile device apps facilitating customer engagement with a retail enterprise in accordance with embodiments of the present disclosure. When the management user operating the management mobile device app 112 (or a counterpart function on a laptop or desktop system) uses the past customer function to send invitations for customers, a priority list of past customers is generated from data accessed by server 109 and/or from data store 110. An invitation with a proposed reservation is sent to the first customer on the priority list and, if accepted, a table is booked for that customer. If the invitation is declined by the first customer on the list, the list is updated and an invitation is sent to the next (now first) customer on the priority list. The process proceeds until all tables are booked, at which time no further invitations are sent.

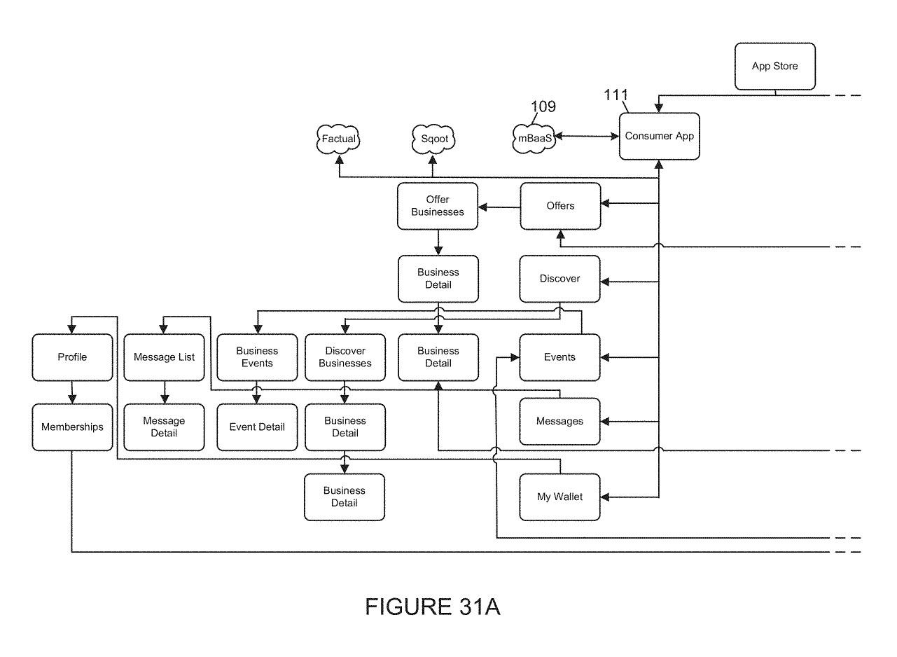

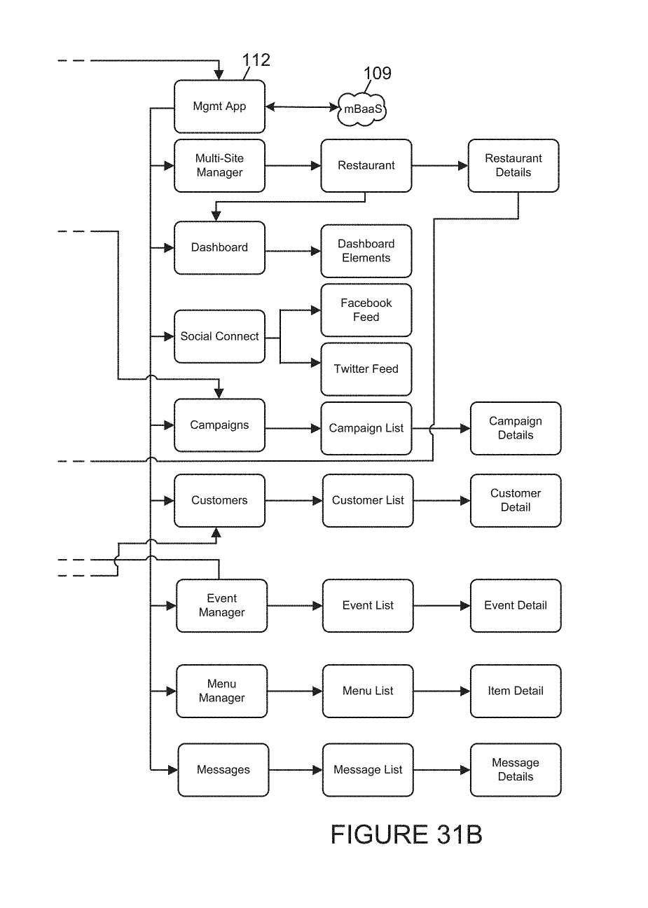

FIGS. 31A-31B are a hierarchical diagram illustrating the general functionality accessible by the customer and management mobile device apps facilitating customer engagement with a retail enterprise in accordance with embodiments of the present disclosure. The functionality of each of customer mobile device app 111 and management mobile device app 112 available from various app stores is depicted.

Embodiments of the invention can be implemented in the form of information processing systems comprising networked computers or other arrangements of networks, clients, servers, processing devices and other components. It should be understood, however, that embodiments of the invention are more generally applicable to a wide variety of other types of information processing systems and associated networks, clients, servers, processing devices or other components.

In some embodiments, a mobile customer engagement platform is integrated with another type of system, such as a big data analytics system. For example, usage data and other information collected or otherwise available in the mobile customer engagement platform can be processed by the big data analytics system in order to characterize preferences, usage patterns or other characteristics of the customers that utilize the mobile customer engagement platform. Such analytics results or portions of the underlying information can be sold or otherwise provided to other organizations or entities. Numerous other types of systems can be integrated with a mobile customer engagement platform in other embodiments.

Communications between the various elements of an information processing system comprising a mobile customer engagement platform may take place over one or more networks. These networks can illustratively include, for example, a global computer network such as the Internet, a wide area network (WAN), a local area network (LAN), a satellite network, a telephone or cable network, a cellular network, a wireless network implemented using a wireless protocol such as WiFi or WiMAX, or various portions or combinations of these and other types of communication networks.

It should be understood that the particular sets of modules and other components implemented in embodiments illustrated in the drawings are presented by way of example only. In other embodiments, only subsets of these components, or additional or alternative sets of components, may be used, and such components may exhibit alternative functionality and configurations.

It was noted above that portions of an information processing system as disclosed herein may be implemented using one or more processing platforms. Illustrative embodiments of such platforms will now be described in greater detail. These processing platforms may also be used to implement at least portions of other information processing systems in other embodiments of the invention.

One illustrative embodiment of a processing platform that may be used to implement at least a portion of an information processing system comprises cloud infrastructure including virtual machines implemented using a hypervisor that runs on physical infrastructure. Such virtual machines may comprise respective processing devices that communicate with one another over one or more networks. The cloud infrastructure further comprises sets of applications running on respective ones of the virtual machines under the control of the hypervisor. It is also possible to use multiple hypervisors each providing a set of virtual machines using at least one underlying physical machine. Different sets of virtual machines provided by one or more hypervisors may be utilized in configuring multiple instances of various components of the system.

Another illustrative embodiment of a processing platform that may be used to implement at least a portion of an information processing system as disclosed herein comprises a plurality of processing devices which communicate with one another over at least one network. The network may comprise any type of network, including by way of example a global computer network such as the Internet, a WAN, a LAN, a satellite network, a telephone or cable network, a cellular network, a wireless network such as a WiFi or WiMAX network, or various portions or combinations of these and other types of networks.

Each processing device of the processing platform comprises a processor coupled to a memory. The processor may comprise a microprocessor, a microcontroller, an application-specific integrated circuit (ASIC), a field-programmable gate array (FPGA) or other type of processing circuitry, as well as portions or combinations of such circuitry elements. The memory may comprise random access memory (RAM), read-only memory (ROM) or other types of memory, in any combination. The memory and other memories disclosed herein should be viewed as illustrative examples of what are more generally referred to as “processor-readable storage media” storing executable program code of one or more software programs.

Articles of manufacture comprising such processor-readable storage media are considered embodiments of the present invention. A given such article of manufacture may comprise, for example, a storage array, a storage disk or an integrated circuit containing RAM, ROM or other electronic memory, or any of a wide variety of other types of computer program products. The term “article of manufacture” as used herein should be understood to exclude transitory, propagating signals.

Also included in the processing device is network interface circuitry, which is used to interface the processing device with the network and other system components, and may comprise conventional transceivers.

Again, these particular processing platforms are presented by way of example only, and an information processing system may include additional or alternative processing platforms, as well as numerous distinct processing platforms in any combination, with each such platform comprising one or more computers, servers, storage devices or other processing devices.

For example, other processing platforms used to implement embodiments of the invention can comprise different types of virtualization infrastructure in place of or in addition to virtualization infrastructure comprising virtual machines. Thus, it is possible in some embodiments that system components can run at least in part in cloud infrastructure or other types of virtualization infrastructure.

It should therefore be understood that in other embodiments different arrangements of additional or alternative elements may be used. At least a subset of these elements may be collectively implemented on a common processing platform, or each such element may be implemented on a separate processing platform.

Also, numerous other arrangements of computers, servers, storage devices or other components are possible in an information processing system. Such components can communicate with other elements of the information processing system over any type of network or other communication media.

As indicated previously, components of the system as disclosed herein can be implemented at least in part in the form of one or more software programs stored in memory and executed by a processor of a processing device. For example, the management and consumer applications are illustratively implemented in the form of software.

Accordingly, a given component of an information processing system implementing a mobile customer engagement platform as described herein is illustratively configured utilizing a corresponding processing device comprising a processor coupled to a memory. The processor executes software code stored in the memory in order to control the performance of processing operations and other functionality. The processing device also comprises a network interface that supports communication over one or more networks.

In addition, embodiments of the invention may be implemented in the form of integrated circuits comprising processing circuitry configured to implement processing operations associated with portions of a mobile customer engagement platform as well as other related functionality.

The particular configurations of information processing systems described herein are exemplary only, and a given such system in other embodiments may include other elements in addition to or in place of those specifically shown, including one or more elements of a type commonly found in a conventional implementation of such a system.

For example, in some embodiments, an information processing system may be configured to utilize the disclosed techniques to provide additional or alternative functionality in other contexts. Thus, techniques illustrated in some embodiments herein in the context of restaurant services can be adapted in a straightforward manner for use in other retail enterprise or enterprise contexts involving various types of interactions with customers or other users. The disclosed techniques can be similarly adapted for use in a wide variety of other types of information processing systems. Accordingly, embodiments of the invention should not be viewed as limited to any particular user engagement contexts.

It is also to be appreciated that the particular process steps used in the flow charts shown in the drawings are exemplary only, and other embodiments can utilize different types and arrangements of processing operations. For example, certain process steps shown as being performed serially in the illustrative embodiments can in other embodiments be performed at least in part in parallel with one another.

It should again be emphasized that the embodiments of the invention as described herein are intended to be illustrative only. Other embodiments of the invention can be implemented utilizing a wide variety of different types and arrangements of information processing systems, networks, and processing devices than those utilized in the particular embodiments described herein. Moreover, the configuration of the management application, consumer application and other system components can be varied in other embodiments. In addition, the particular assumptions made herein in the context of describing certain embodiments need not apply in other embodiments. These and numerous other alternative embodiments will be readily apparent to those skilled in the art.

While each process flow and/or event sequence depicted in the figures and described herein involves a sequence of steps and/or events, occurring either in series or in tandem, unless explicitly stated or otherwise self-evident, no inference should be drawn regarding specific order of performance of steps or occurrence of events, performance of steps or portions thereof or occurrence of events serially rather than concurrently or in an overlapping manner, or performance the steps or occurrence of the events depicted exclusively without the occurrence of intervening or intermediate steps or events. Moreover, those skilled in the art will recognize that complete processes and event sequences are not illustrated or described. Instead, for simplicity and clarity, only so much of the respective processes and event sequences as is unique to the present disclosure or necessary for an understanding of the present disclosure is depicted and described. Still further, the description of different embodiment is not meant to imply that features of the embodiments are necessarily mutually exclusive. Aspects of different embodiments may be readily combined.

While this disclosure has described certain embodiments and generally associated methods, alterations and permutations of these embodiments and methods will be apparent to those skilled in the art. Accordingly, the descriptions of example embodiments do not define or constrain this disclosure. Other changes, substitutions, and alterations are also possible without departing from the spirit and scope of this disclosure, as defined by the following claims.

What is claimed is:

1. A method, comprising:
receiving, at one or more servers for a mobile application associated with a retail enterprise that are configured to serve both customer mobile applications associated with the retail enterprise and management mobile applications associated with the retail enterprise, an indication that a customer mobile device executing a customer mobile application associated with the retail enterprise has connected to a small area connectivity system operated on premises of the retail enterprise and having a coverage extending only to service and entry areas of the retail enterprise premises; and
in response to receiving the indication of the customer mobile device connection to the small area connectivity system,
transmitting, from the one or more servers to a first management mobile application executing on a first mobile device carried by a first retail enterprise employee, a notification including at least a name and a photo for a customer associated with the customer mobile device executing the customer mobile application, and
determining, by the one or more servers, a classification of the customer by the retail enterprise based at least on one or more of a number of prior visits by the customer to the retail enterprise, a number of reviews of the retail enterprise posted by the customer, and a total amount spent by the customer at the retail enterprise.

2. The method of claim 1, further comprising:
upon determining the classification of the customer is a very important person classification and receiving, at the one or more servers from the first management mobile device application subsequent to the transmitted notification, information regarding a seating location of the customer, transmitting, from the one or more servers to a second management mobile application executing on a second mobile device carried by a second retail enterprise employee, an alert regarding the customer and the customer seating location.

3. The method of claim 2, wherein the alert is transmitted to the second management mobile application even if the second mobile device executing the second management mobile application is located away from the retail enterprise premises.

4. The method of claim 1, wherein the customer mobile application executing on the customer mobile device is configured to cause the customer mobile device to automatically discover and connect to the retail enterprise small area connectivity system upon entry of the customer mobile device into a coverage of the retail enterprise small area connectivity system and, upon connection, trigger the connection indication received at one or more servers.
